(19) United States
(12) Patent Application Publication
(10) Pub. No.: US 2015/0279122 A1
(43) Pub. Date: Oct. 1, 2015

(54) METHOD AND DEVICES FOR COLLECTING A TRAFFIC-RELATED TOLL FEE

(71) Applicant: TOLL COLLECT GMBH, Berlin (DE)

(72) Inventor: Dirk Lorenzen, Furstenberg (DE)

(73) Assignee: TOLL COLLECT GMBH, Berlin (DE)

(21) Appl. No.: 14/436,454

(22) PCT Filed: Oct. 17, 2013
(86) PCT No.: PCT/EP2013/003162

§ 371 Date: Apr. 16, 2015

(30) Foreign Application Priority Data
Oct. 17, 2012 (EP) 12075118.5

(51) Int. Cl. G07B 15/06; H04W 4/12; H04L 29/08

(52) U.S. Cl. CPC G07B 15/063; H04L 67/12; H04W 4/12

(57) ABSTRACT

The invention relates to a method for collecting a traffic-related toll fee in a tolling system for at least one vehicle engaged in traffic. The method has the steps of wirelessly receiving and data-processing at least one first message from a group of multiple vehicles, said message being generated and wirelessly transmitted by a first vehicle as a result of an extraordinary traffic event detected by the first vehicle, and collecting a traffic-related toll fee for a second vehicle, which has likewise detected the extraordinary traffic event, depending on the result of the data-processing of the first message. The invention also relates to a vehicle device and to a central data-processing device with which at least sub-steps of such a method can be carried out.

### CROSS REFERENCE TO RELATED APPLICATIONS

This patent application is the U.S. national phase of International Application No. PCT/EP2013/003162 filed on Oct. 17, 2013, and published on Apr. 24, 2014 as International Publication No. WO 2014/060117 A1, which application claims priority to European Patent Application No. 12075118.5 filed on Oct. 17, 2012, the contents of all of which are incorporated herein by reference.

### TECHNICAL FIELD

The invention relates to a method and to a vehicle-side device and to a central device of a toll system for collecting traffic-related toll fees, relating in particular to a route section, for vehicles which are participating in the traffic, and in particular are traveling on said route section.

### BACKGROUND

In this context, traffic-related toll fees, which can also be referred to as traffic-dependent toll fees, differ from customary use-related (use-dependent) toll fees insofar as use-related toll fees have to be paid by every road user for merely using a toll-liable piece of infrastructure (for example a road) independently of other road users, whereas traffic-related toll fees have to be paid or reimbursed in addition to or less the use-related toll fee (if the latter is provided) by a road user as a function of the occurrence of at least one other road user on said toll-liable piece of infrastructure. In this respect, traffic-related toll fees always signify a change in the use-related toll fee which, insofar as one is provided, would be payable in any case by an individual vehicle, wherein the traffic-related toll fee is payable given the occurrence of an exceptional traffic event in which a plurality of vehicles are involved. In this sense, the term traffic is used as an expression for the simultaneous use of a piece of infrastructure by a plurality of vehicles.

From the point of view of environmental technology and logistics there is a need to maintain the traffic flow on route sections of a road network and to keep the air pollution due to exhaust gases from vehicles below a limiting value. A possible way of influencing the driving behavior and/or of compensating economic disadvantages resulting from increased traffic density or resulting from a reduced traffic flow is to provide a traffic-density-dependent toll fee on route sections which are at risk of backed-up traffic and increased exhaust gas loading. For this purpose, parameters which are dependent on traffic density/traffic flow or which represent traffic density or traffic flow have to be measured and evaluated.

The laid-open patent applications WO 2002 071 338 A1, EP 1 482 451 A2, DE 196 34 340 A1 and WO 2009 149 099 A1 disclose that such traffic density parameters are monitored continuously by means of roadside devices and/or a central device on a first road section, and when a threshold value of the traffic density parameter is exceeded or undershot a changed toll fee for the first road section is defined and displayed to a vehicle driver on a road section preceding the first section in the direction counter to the direction of travel.

This display can occur on the roadside at the road section preceding the respective one (WO 2009 149 099 A1), or on the on-board unit (OBU) after was transmitted by means tracking the position of OBUs by mobile radio to the OBU to a vehicle on the respective preceding section (WO 2002 071 338 A1, EP 1 482 451 A2) or via radio, without the vehicles having to be identified on a centralized basis (DE 196 34 340 A1).

The method as a whole is subject to the disadvantageous fact that traffic density parameters or traffic flow parameters have to be acquired, on the one hand, by a road-side device and, on the other hand, continuously on a centralized basis, which means a very large expenditure on technical infrastructure. In addition, it seems legally questionable to demand increased toll fees from vehicles following on a route section preceding the overloaded route section, while the vehicles which are involved in the blockage/environmental stress on the affected route section are not to be subjected to said increased toll fees.

It appears to be even more problematic to collect an increased toll fee from a first vehicle traveling on the affected route section if the traffic at this point has started to flow again on the affected route section, in other words the condition which triggers an increase in the toll has already been eliminated again at the time of use. In this context a situation in which the first vehicle on the preceding section is overtaken by a second vehicle which, when traveling on the preceding route section, did not, in contrast to the first vehicle, receive a toll increase message owing to a breakup of the traffic jam having been registered in the meantime, is particularly paradoxical.

In this context, it also cannot be an objective of a toll operator or toll collection service provider to inform vehicles on preceding route sections about an increased toll fee which occurs owing to a situation and is collected on a following route section.

The vehicle driver can in fact also be informed about the generally possible increased toll fees which occur owing to the situation by the general business conditions with which an upper limit for possible toll fees for a route section is communicated. The information about exceptional traffic situations which occur in relation to traffic in preceding route sections and which (can) lead to increased toll fees can instead be left to traffic information services.

Laid-open patent application WO 2011 129 800 A1, which makes no reference to a toll system, proposes continuously receiving data relating to the driving behavior of the driver of a vehicle (vehicle identification, current vehicle position, current vehicle speed) from this vehicle and examining this data, on the one hand, for an infringement and, on the other hand, using said data to perform an analysis in respect of location-dependent or time-dependent traffic conditions.

### SUMMARY

Irrespective of the above, the object of the invention is to provide methods and devices for collecting a traffic-related toll fee which avoids the specified disadvantages.

In particular, an object of the invention is to provide a toll system for collecting traffic-related toll fees which does not require road-side traffic sensing infrastructure and to make available a method and devices with which a toll which is increased owing to traffic density is collected from those vehicles on a route section which are involved in the increased traffic density and/or air pollution on the respective route section, wherein the communication volume within a radio network which is involved in this method is to be kept low.

This object can be achieved by means of a method as claimed in claim 1, a vehicle device as claimed in claim 12 and a central data processing unit as claimed in claim 14.

Independent product claims 12 and 14 present two alternatives—a mobile decentralized device and a fixed central device—for realizing the single inventive concept which is implemented by method claim 1.

Preferred embodiments are the subject matter of the dependent claims.

The invention will be explained in more detail below in terms of its various aspects, wherein features, embodiments and advantages of one aspect of the invention are to be considered to be capable of being transferred to all other aspects of the invention insofar as such a transfer does not give rise to a contradiction.

According to a first aspect, a method for collecting a traffic-related toll fee for at least one vehicle which is part of a toll-determining group of a plurality of vehicles, includes (a) radio reception of at least one first message which was generated by a first vehicle as a result of at least one first detection report made by at least one first vehicle about the occurrence of an exceptional traffic event, and was transmitted by radio, including data of the first detection report, (b) the production of a second detection report about the occurrence of an exceptional traffic event by a second vehicle, and (c) the collection of a traffic-related toll fee for the first vehicle and/or the second vehicle, if a comparison of data of the first detection report from the first message and data of the second detection report in the course of data processing of this data by a processor reveals a similarity between these data items within a predefined scope, which similarity causes that the first vehicle and the second vehicle are assigned to the toll-determining group.

In this context, data of the second detection report which is used as the basis for the data comparison with data of the first detection report is generated with the second detection report from the second vehicle.

The involvement of a first and second vehicle in a toll-determining group of vehicles means that the first and second vehicles are included in this toll-determining group of vehicles. In this context, the toll-determining group of vehicles arises on account of the similarity between data items of the first detection report and data items of the second detection report, wherein according to the invention this similarity is determined by means of a technical entity, specifically a processor to which these data items are made available. The recognition of the similarity between the data items is already to be considered here an inventive measure of the formation of groups carried out on the first vehicle and the second vehicle to form the toll-determining vehicle group, which according to the invention does not have to have any further vehicles but can have further vehicles—the latter possibility not being excluded according to the invention either.

In principle, the inventive collection of a traffic-related toll fee is based on the detection of common features in exceptional traffic events which are detected by a plurality of vehicles.

According to the invention, such a traffic-related toll fee is not collected before the similarity between the data items of the first detection report and the data items of the second detection report has been checked; subsequently, said toll fee is also collected only if the similarity between the data items has been detected. That is to say, the detection of the similarity between the data items triggers the toll collection—or in other words: the collection of the toll is the result of said similarity between the data items. In this respect, the traffic-related toll collection according to the invention differs completely from the known, use-related toll collection during which, in the case of checking, the subsequent collection of the use-related toll fee is triggered when data items of the toll-liable vehicle incorrectly differ from the data items of a checking entity—for example a control vehicle—that is to say are dissimilar.

This differentiates the invention basically from the checking method described in German laid-open application DE 10 2007 035 738 A1 in which positions of a toll-liable vehicle are transmitted together with an identifier of the toll-liable vehicle from the toll-liable vehicle to a control center (in order to determine from these positions a possibly payable, use-related toll fee relating to the toll-liable vehicle independently of the data of other vehicles), positions of a checking vehicle together with an identifier of the toll-liable vehicle are transmitted to the control center, and the positions of the toll-liable vehicle are compared with the positions of the checking vehicle in the control center, in order to output a fault signal in the event of a significant deviation. Whereas in the case of the use-related toll principle the collection of a toll is generally carried out individually for each individual user as such, independently of other users, and only in the exceptional case of a failure is a subsequent collection method initiated in relation to the defaulting user as a function of the reference data of a checking entity—which generally participates in the traffic—in the case of the traffic-related toll principle according to the invention the collection of a toll for a plurality of users as road users is generally carried out communally as a function of other users. In principle, the common participation of the first vehicle and of the second vehicle in a specific, exceptional traffic event brings about the traffic-related collection of the tolls both for the first vehicle and for the second vehicle.

In summary, in the method according to the invention the usual (traffic-related) collection of tolls is brought about by the occurrence of similarity between the data items of two vehicles of the same ranking, whereas in the known checking methods the unusual (use-related) collection of tolls is brought about by the lack of similarity between the data items of two vehicles of different ranking.

Any event which impedes the regular flow of traffic or represents an impeded traffic flow is understood to be an exceptional traffic event.

Exceptional traffic events include events which are caused by an exceptional traffic situation with increased traffic density (that is to say increased number of vehicles on a route section) in the form of slowly moving traffic, stop-and-go traffic or a traffic jam: for example a reduced vehicle speed, a vehicle stop, a reduced inter-vehicle distance as well as increased fine dust loading or increased exhaust gas loading in the surroundings of the vehicle.

A traffic jam is understood here to be a stationary state of a plurality of vehicles following one another directly on a roadway, slowly moving traffic is understood to mean the movement of a plurality of vehicles following one another directly on the section of a roadway at a speed which is significantly (for example more than 30%) below the permissible maximum speed or the proposed recommended speed for said section of roadway. Stop-and-go traffic is understood to be the—possibly repeatedly occurring—changeover between (slowly) moving traffic, a traffic jam and back to (slowly) moving traffic. Slowly moving traffic is generally additionally characterized in that the inter-vehicle distance between two vehicles which directly follow one another and are involved in slowly moving traffic is less than twice the prescribed safety inter-vehicle distance (see, for example, paragraph 4 and section 273 of the German highway code or the “rule of thumb that the safety inter-vehicle distance is equal to half what is on the speedometer”, that is to say: the speed of the vehicle in units of kilometers per hour divided by two gives the safety inter-vehicle distance value in units of meters).

While a regular traffic event is represented, for example, by a vehicle speed of over 60 km/h on the freeway or a inter-vehicle distance of over 30 m, and is indicative of a regular traffic situation of flowing traffic, an exceptional traffic situation of backing-up or slowly moving traffic is indicated when there is an exceptional traffic event of a vehicle speed of below 50 km/h or a inter-vehicle distance of below 20 m.

The assignment of the first vehicle and of the second vehicle to the toll-determining group on the basis of the positive comparison result ensures that the second vehicle detects exceptional traffic events of the same exceptional traffic situation as the first vehicle in the sense that the detected exceptional traffic events have a chronological and spatial relationship. This is essential and advantageous according to the invention in order to exclude the possibility of a traffic-related toll being collected for a vehicle for an exceptional traffic situation in which it is not involved.

In addition, the detection reports about the occurrence of an exceptional traffic event in the vehicles themselves are essential to the invention. It is therefore advantageously possible to avoid periodic transmission and/or reception of data which is intended to permit a centralized detection report about the occurrence of an exceptional traffic event, with the result that the number of transmitted messages and/or the communicated data volume in a toll system in which the method according to the invention is carried out is significantly reduced compared to the prior art, because data is transmitted on an event-related basis only when an exceptional traffic event is detected by the respective vehicle.

The exceptional traffic events are preferably of the same type (reduced vehicle speed, vehicle stop, reduced inter-vehicle distance, increased fine dust loading, increased exhaust gas loading) or can be assigned to the same exceptional traffic situation (increased traffic density, slowly moving traffic, traffic jam).

This permits homogenous detection of the toll-incurring traffic situation.

In principle, by predefining the scope for every second vehicle a separate, toll-determining group of vehicles, which is assigned to said second vehicle, is formed, said group comprising at least a first vehicle—generally in most cases a plurality of first vehicles—and in each case said second vehicle.

In this respect it is possible to provide, in particular, that the method according to the invention comprises the collection of a traffic-related toll fee for the first vehicle and for the second vehicle. In this way, a method is provided for the traffic-related collection of tolls for a plurality of vehicles which are involved in a toll-determining group of a plurality of vehicles. Through the involvement in a common exceptional traffic situation, which is detected through the similarity between the data items of the first detection report and of the second detection report by means of the processor, in principle both vehicles can in fact be affected by the collection of the traffic-related toll fee.

In this context, a first toll fee for the first vehicle and a second toll fee for the second vehicle does not necessarily have to be of the same magnitude. For example, they can be different depending on the type of vehicle or depending on the number or magnitude of traffic-related toll fees which were collected for the respective vehicle in a preceding, predetermined time frame.

In accordance with embodiments, the data processing by comparing chronological data of the first detection report and of the second detection report may conclude with the result that the chronological data lies within a predefined time frame.

A chronological causal relationship between the first detection report and the second detection report can therefore be determined, which relationship can form a first condition for the assignment of the first vehicle and of the second vehicle to the toll-determining vehicle group.

For example, the time frame can be a minute, and all the vehicles whose chronological data is within a minute belong to the toll-determining group.

It is also possible for the comparison also to detect correspondence between the chronological data items, wherein the predefined time frame is limited to a single time value. This can be possible, for example, by virtue of the fact that a) chronological data is only made available rounded to whole minutes and/or is subjected to the comparison or a data record of the detection reports contains a plurality of chronological data items which have equal status with respect to the comparison and which have minute information which is rounded down or up to whole minutes, and if appropriate, further preceding or following minute information.

In accordance with embodiments, the data processing by comparing local data and/or direction-of-travel-related data of the first detection report and of the second detection report concludes with the result that the local data lies within a predefined spatial region and/or the direction-of-travel-related data lies within a predefined angular range.

A spatial causal relationship can therefore be determined between the first detection report and the second detection report, which relationship can form a first or second condition for the assignment of the first vehicle and of the second vehicle to the toll-determining vehicle group.

For example, on the basis of the direction-of-travel-related data it is possible to determine whether the first vehicle and the second vehicle are using the same roadway and are therefore involved in the same traffic situation, or whether the first vehicle and the second vehicle are using roadways running in opposite directions and are therefore involved in different traffic situations which exclude them from the collection of a traffic-related toll fee.

For example, on the basis of the local data it is possible to determine whether the first vehicle and the second vehicle are using the same route section or route sections which are directly adjacent to one another, and therefore whether said vehicles are involved in the same traffic situation, or whether the first vehicle and the second vehicle are using different route sections or route sections which are not directly adjacent to one another and are therefore involved in different traffic situations which exclude them from the collection of a traffic-related toll fee.

The method according to the invention can also provide (d) the production of a third detection report about the occurrence of an exceptional traffic event by a third vehicle, (e) the radio reception of a second message which was generated as a result of the second detection report which was produced by the second vehicle and was transmitted by radio including data of the second detection report, and (f) the collection of a toll fee for the first, second and/or third vehicles if a comparison of data items of the first detection report from the first message, data items of the second detection report and data items of the third detection report in the course of data processing of these data items by a processor reveals a similarity between these data items within a predefined scope, which similarity causes that the first vehicle, the second vehicle and the third vehicle are assigned to the toll-determining group.

Generally, the method according to the invention can, for each entire N>0 (a) the production of N+1 detection reports about the occurrence of an exceptional traffic event by, in each case, one of N+1 vehicles, (b) the radio reception of at least N messages which were generated by the respective vehicle as a result, in each case, of a detection report, produced by N vehicles, about the occurrence of an exceptional traffic event, and was transmitted by radio, including data of the respective detection report, and (c) the collection of a traffic-related toll fee for at least one of the N+1 vehicles if a comparison of the data items of the N+1 detection reports in the course of data processing of these data items by a processor reveals a similarity between these data items within a predefined scope which causes that the N+1 vehicles are assigned to the toll-determining group.

In principle, the integer N is limited to the maximum possible number of the vehicles involved in a traffic jam. For a traffic jam of 100 km on a four-lane roadway, N can assume a value of 100,000.

However, it appears appropriate to provide a vehicle-related, smallest toll-determining group. According to the invention, the smallest toll-determining group is composed of two vehicles. On a single-lane roadway this number may already be sufficient to identify an exceptional traffic event—for example an accident on the basis of a stationary state occurring over a predetermined time interval. If this smallest number of vehicles is not sufficient to identify an exceptional traffic event (for example slowly moving traffic or an accident on a multi-lane roadway), the minimum number of vehicles forming the toll-determining group can thus be increased. In this case, the toll-determining group can require 3 or more, for example 10, vehicles.

With respect to more than two vehicles involved in the toll-determining group of vehicles it is possible to describe the following embodiment:

Preferably a plurality of first messages are received which were generated by the first vehicles as a result of in each case at least one first detection report, produced by the plurality of first vehicles, about the occurrence of an exceptional traffic event, including data of the first detection report, and were transmitted by radio, wherein a traffic-related toll fee is collected for one or more of the first vehicles and/or for the second vehicle if a comparison of data items of the first detection reports from the first messages and of the second detection report in the course of data processing of these data items by a processor reveals a similarity between these data items within a predefined scope, which similarity causes that the first vehicles and the second vehicle are assigned to the toll-determining group.

In this context it is possible that the first vehicles pass on messages which they have received from first vehicles by retransmission. A short range of one of first messages can therefore be increased incrementally in order to transmit the messages to further first vehicles and finally to the second vehicle. In this context, a counter in the message data record can be incremented by one unit whenever a first message is emitted anew, and a criterion for the aborting of the passing-on of a first message can be defined which fails to increment the counter above a maximum counter reading.

A relationship which is determined by comparison of chronological data items of the first detection reports and of the second detection report is preferably of a chronological causal nature in the sense that the detection report about the exceptional traffic event by the second vehicle is included in the detection report about exceptional traffic events of the first vehicles in such a way that the time of the detection of an exceptional traffic event of the second vehicle lies within a time range which is dependent on the time interval between two points of the detection reports about the exceptional traffic events by two first vehicles.

For example, a chronological, causal relationship is present between an exceptional traffic event detected by a second vehicle and the exceptional traffic event detected by a plurality of first vehicles, if the second time interval between a second time of the detection of the exceptional traffic event detected by the second vehicle and a first time of the detection of an exceptional traffic event detected by a first vehicles is shorter than the first time interval between two first times of two (not necessarily directly successive) detections of exceptional traffic events of two first vehicles or a fraction of this first time interval. It is the responsibility of the person skilled in the art here to define how long at the maximum the first time interval can be between two first times of two detections of exceptional traffic events of two first vehicles so that a second time which chronologically precedes or follows these two first times to still be covered by this chronological causality criterion.

The maximum first time interval between two first vehicles of the toll-determining group can be referred to as a detection time frame which represents the duration of a detection time period between a start and an end of the detection of the exceptional traffic events which are detected by first vehicles. This detection time frame consequently defines the time frame within which detections of exceptional traffic events can be assigned to the toll-determining group. Within the time period of the detection time frame or a fraction thereof, there are detections of exceptional traffic events of two vehicles before, after or within the detection frame in a chronological relationship with the detections of exceptional traffic events of first vehicles, as a result of which such a second vehicle is assigned to the toll-determining group of vehicles whose common involvement in an exceptional traffic situation has been detected according to the invention.

The number of first vehicles and/or second vehicles of the toll-determining group of vehicles can be referred to as the detection quantity. The quotient of this detection quantity and detection time frame provides a toll liability rate (in units of vehicles per second), and its reciprocal value provides a toll liability interval. Both represent a toll-triggering traffic density given detections of exceptional traffic events.

With such a toll liability interval of, for example, 10 seconds, a toll-free traffic jam owing to an accident on a route section with little traffic can be differentiated from a traffic jam owing to increased traffic density on a route section with heavy traffic, within a detection time frame of a minute and a detection quantity of six first vehicles and/or second vehicles, with the result that a traffic jam owing to increased traffic density gives rise to the collection of the traffic-related toll, but a traffic jam purely due to an accident in the case of low traffic density does not: In a first preferred embodiment, the second time of the detection of an exceptional traffic event which is detected by the second vehicle lies in a toll-triggering fashion within a time period of twice a defined toll liability interval which directly precedes or follows a detection time period of exceptional traffic events which are detected by first vehicles.

In a second preferred embodiment, the second time of the detection of an exceptional traffic event which is detected by the second vehicle lies in a toll-triggering fashion between two first times of the detections of an exceptional traffic event by two second vehicles which follow one another within twice a defined toll liability interval.

In a third, less preferred embodiment, the shortest time interval between the time of the detection of the exceptional traffic event by a first vehicle and the time of the detection of the exceptional traffic event by the second vehicle is, in a toll-triggering fashion, not longer than the longest time interval between two times of directly chronologically successive detections of the exceptional traffic event by two first vehicles.

Generally it is possible to state that the collection of a toll relating to the second vehicle preferably takes place when the evaluation of the first times of first detections of exceptional traffic events of the first vehicles, and of the second time of the second detection of an exceptional traffic event of the second vehicle, reveals that the first times are contained together with the second time in a predefinable chronological detection interval.

In this context, it is possible to graduate the detection intervals according to their magnitude for the collection of multiple or different traffic-related toll fees which are dependent on the severity of the exceptional traffic situation.

The same applies analogously to the local and/or direction-of-travel-related data:

A relationship which is determined by the comparison of local data items of the first detections and of the second detection is preferably of a spatial causal nature in the sense that the detection of the exceptional traffic event by the second vehicle is included in the detection of exceptional traffic events of the first vehicles in such a way that the location of the detection of an exceptional traffic event of the second vehicle lies within a spatial region which is dependent on the spatial distance between two locations of the detection of exceptional traffic events by two first vehicles.

Generally, it is possible to state that the collection of a toll relating to the second vehicle preferably takes place when the evaluation of the first locations of first detections of an exceptional traffic event of the first vehicles and of the second location of the second detection of an exceptional traffic event of the second vehicle reveals that the first locations are contained, together with the second location, in a predefinable spatial region. In this context, it is possible to graduate staggering the magnitude of the spatial regions for the collection of multiple or different traffic-related toll fees which are dependent on the severity of the exceptional traffic situation.

It is to be noted here that causality can also be established by excluding from the data processing one or more first messages from one or more first vehicles which would stand counter to this causality principle with the result of a toll collection failing to occur, in order to provide justification for this toll collection.

In order to determine the magnitude of the exceptional traffic event, the number of vehicles which are involved in more than one toll-determining group relating to an individual vehicle can be determined. If, for example, (a) vehicle 1 forms a first toll-determining group with vehicle 2 and vehicle 3, and (b) vehicle 2 forms a second toll-determining group with vehicle 3 and vehicle 4, all the vehicles 1, 2, 3 and 4 are coupled to one another via the first and second toll-determining group, by means of their common members 2 and 3, and form an exceptional traffic event with 4 involved vehicles. If in general N vehicles are involved in each case in the formation of a group which determines the tolls for a total of Z, by way of approximation it is possible to assume a total of Z/N vehicles involved in the exceptional traffic event.

In this context, the invention can be designed to determine the magnitude of the traffic-related toll fee for the first and/or second vehicle as a function of the number of all the vehicles involved in the exceptional traffic event and to collect said toll fee, wherein the number of all the vehicles involved in the exceptional traffic event is determined by counting the number of all the different vehicles which are included in the totality of all the toll-determining groups which are linked to one another via interfaces of identical vehicles, wherein the linking of, in each case, a first toll-determining group with a second toll-determining group is detected in that at least one linking vehicle, which is included in the first and the second toll-determining groups, is determined, and the vehicle's data of a detection report about the occurrence of an exceptional traffic event, said data having brought about an assignment of the linking vehicle to the first toll-determining group, have a similarity, within a predefined scope, to the data of a detection report about the occurrence of an exceptional traffic event, said data having brought about an assignment to the second toll-determining group.

In particular it is possible to provide that the collection of a traffic-related toll fee relating to the first and/or second vehicle does not take place until the number of toll-determining groups which are linked in this way, and of which at least one includes the first and the second vehicle exceeds a group threshold value (of for example 10 toll-determining groups) or the number of vehicles involved in the exceptional traffic event exceeds a vehicle threshold value (of for example 100 vehicles).

The invention provides having a traffic situation determined by a first and a second vehicle themselves and transmitting a message from the first vehicle about the occurrence of a specific traffic situation only in the case of detection of an event brought about by the traffic situation—in an event-controlled fashion. When a specific minimum number of these messages whose triggering detection was generated by first vehicles in a scope which is predefined with respect to the second vehicle is received, the toll fee for the second vehicle which has also detected such an exceptional traffic event is advantageously adapted, for example for the vehicle device of a second vehicle which has registered such an exceptional traffic event.

Only the vehicle which is involved in a traffic situation (a traffic jam or increased air pollution) is advantageously subjected to an increased toll fee and its involvement in said traffic situation also detected.

In an ideal case, even the party causing an exceptional traffic situation, for example a traffic jam, can be identified and obliged to pay (an increased) toll fee. The invention therefore differs entirely from the methods in the prior art mentioned in the introduction, which methods are limited to threatening a party uninvolved in congestion with an (increased) toll fee and to allowing to go unpunished those parties which were involved in the congestion from the beginning—and are even possibly the cause thereof.

Since an individual message or detection report arising from an exceptional traffic situation which covers a large area and which can include slowly moving traffic, a traffic jam or excessive air pollution, generally due to a large number of involved vehicles, is not sufficient for the decision about the actual occurrence of said exceptional traffic situation, according to the invention it is advantageously possible to prevent a decision which takes into account the detections report about an exceptional traffic event, characterizing the traffic situation over a large area, by a plurality of vehicles (at least a first and a second vehicle) from resulting in a single vehicle being unjustifiably subjected to an (increased) toll fee for an individual driving maneuver (driving up too closely to the vehicle ahead as a result of the sudden cutting-in of an overtaking vehicle or stopping on the hard shoulder due to a fault). According to the invention, only the detection of a plurality of exceptional traffic events can serve as a basis for the identification of an exceptional traffic situation and the involvement in said traffic situation of those vehicles which have detected the exceptional traffic events, with the result that a traffic-related toll is collected for at least one of the involved vehicles.

Since the detection report about the occurrence of an exceptional traffic event does not take place centrally but rather in a decentralized fashion in the invention, in contrast to the solutions known for serving as a basis for a traffic-related toll fee which are known from the prior art, the communication volume is sporadic on an event-dependent basis according to the invention and is not continuous independently of events. Instead of compulsorily receiving signals or messages periodically from vehicles or road-side devices centrally in order to process the latter centrally with respect to the detection of an exceptional traffic event or a plurality of exceptional traffic events, a message is transmitted only when the exceptional traffic event is detected. The communication volume from the vehicle, but at least that which has to be processed by a control center, can therefore advantageously be drastically reduced to the essential messages—specifically those about the detection of a possibly toll-incurring exceptional traffic situation.

This is possible according to the invention by virtue of the fact that the vehicles are enabled to sense the traffic situation themselves by sensor and evaluate the sensed results in order to detect an exceptional traffic event. Instead, in the prior art communication-intensive solutions are proposed which are based on sensing of the traffic by sensor by means of a superordinate entity and on central or road-side evaluation.

A decision as to whether the exceptional traffic event which is signaled by a first vehicle or a plurality of first vehicles is actually toll-incurring for a second vehicle, is carried out by an individual analysis for each second vehicle which is possibly also involved in the traffic situation which brings about the exceptional traffic event—for example in the second vehicle itself, in a central data processing unit or in one of the first vehicles or in a third vehicle. The detection of tolls being incurred for a traffic situation by the data processing of interdependent partial results of evaluations of multiple, possibly different, entities, is also conceivable. It is therefore advantageously ensured that tolls are collected in a way which is appropriate for the road users.

The invention is focused not on the business method aspect of the collection of tolls per se but rather on the technical solution which gives rise to the collection of tolls. In this sense it is a business method to define whether the collected toll fee is positive, negative or even zero. A positive toll fee corresponds to the payment of a toll by the user to the toll operator or a toll collection service provider; a negative toll fee corresponds to the payment of a toll by the toll operator or the toll collection service provider to the user. A positive traffic-related toll fee can mean here a supplement to the basic fee of a purely use-related toll; and a negative toll fee can mean (partial) refunding of a basic fee. Both types of basic fees have their justification under certain circumstances, depending on the infrastructure conditions: an intact route section which is known to be frequently subject to traffic jams owing to increased traffic volume can be subject to a positive traffic-related toll if congestion-free alternative routes are available. The toll which is additionally levied as a function of the traffic on top of the basic fee for use can be used to finance widening of lanes of this section. A route section which has road works with a constriction of, for example, two lanes to one lane will trigger a traffic jam or slowly moving traffic even in the case of a low traffic volume. If there are no equivalent, blockage-free alternative routes for this route section, car drivers can be compensated for their time wasted in the traffic jam with a reduction in the toll.

An example of the business method case of the collection of no toll fee can be considered to be the principle according to which initially a maximum toll is collected as a matter of principle from all users when they travel on the route section, as a sum of a use-related basic fee and traffic-related additional toll in anticipation of a possible (additional) toll-triggering traffic situation on this section. If involvement of the second vehicle in such a toll-triggering traffic situation up to exiting from the route section cannot be determined (for example because a regular traffic situation was always present in the course of the entire route section), then the additional toll which was ex ante levied excessively is automatically refunded or credited. However, if involvement of the second vehicle in such a toll-incurring, exceptional traffic situation which triggers the additional toll can be determined on this route section in an inventive fashion, the collection of the additional toll is proven ex post to be justified. According to the invention, the driver is informed by this detection about the collection of a zero toll as confirmation for the correct collection of the maximum toll.

Even without the construct of the zero toll, the collection of the traffic-related toll fee for a second vehicle remains even when the route section is traveled on within the scope of the invention because it is only a question of business methodology whether the additional toll is collected after the identification of the exceptional traffic situation or even before the identification of the exceptional traffic situation. The technical process which leads to a traffic-related toll fee being ultimately effectively collected for a first and/or second vehicle is essential to the invention.

The involvement of a first vehicle in a toll-incurring traffic situation can be detected in the second vehicle. This is advantageous if the first vehicle cannot receive, but can only transmit, for technical reasons.

The involvement of a second vehicle in a toll-incurring traffic situation can be detected in the second vehicle itself. This is advantageous if the second vehicle cannot transmit but can only receive, for technical reasons.

The involvement of a first and of a second vehicle in a toll-incurring traffic situation can also be detected both in the second vehicle and in the first vehicle. This is advantageous if one of the first and/or second vehicles cannot transmit but can only receive or cannot receive but can only transmit for technical reasons. Instructions for the collection of a toll for the first vehicle and the second vehicle can be transmitted both by the first vehicle and by the second vehicle to the central data processing unit of a toll system, which data processing unit processes these instructions in such a way that despite toll collection instructions being possibly present in duplicate a toll for the first and/or the second vehicle is collected only once.

Preferred embodiments of the invention provide that route-section-related toll fees are collected in the toll system for vehicles which travel along the respective route section, and the collection of the traffic-related toll fee is related to that route section on which the exceptional traffic event was detected by the second vehicle. A spatial limitation of the traffic-related toll fee can therefore be performed.

In particular when the collection of the traffic-related toll fee is related to that route section on which the exceptional traffic event was detected both by first vehicles and by the second vehicle, it is possible for there to be correspondence to the desired spatial causality between first vehicles and second vehicles.

Further developments of these embodiments provide that the collection of the traffic-related toll fee is related to that route section on which the exceptional traffic event was detected by the second vehicle and the first vehicles, and the first messages each comprise an identifier of that route section on which the exceptional traffic event was detected in each case by the first vehicles. As a result, the messages which were received by the first vehicles can be processed in relation to the route section, and can be related to the route section on which the second vehicle has also detected an exceptional traffic event.

It is possible to graduate traffic-related toll fees according to the severity of the exceptional traffic event (a plurality of speed limits of 10 km/h, 30 km/h and 50 km/h; a plurality of inter-vehicle distance limits of 20 m, 10 m and 5 m; stationary periods in a traffic jam of 10 sec, 1 min, 10 min, 1 h; a plurality of fine dust concentration values of 25 μg/m³, 50 μg/m³ and 100 μg/m³), and/or on the basis of the number of their detections (length of the traffic jam, number of the vehicles involved in the slowly moving traffic/the environmental pollution) according to the size of the exceptional traffic situation.

Therefore, for the determination of the severity of the exceptional traffic event, first and second limiting values can be provided for measured values for the detection of a plurality of exceptional traffic events of differing severities, wherein the exceeding or undershooting of the first limiting value can give rise to a first traffic-related toll, and the exceeding or undershooting of a second limiting value can give rise to a second traffic-related toll, which can be collected alternatively or cumulatively with respect to the first traffic-related toll.

In addition it can be provided that the reception of a message or of a plurality of messages relating to the exceeding or undershooting of a second limiting value by a third vehicle or of a group of third vehicles is added to the first messages or subtracted therefrom, with the result that the collection of the first and/or second traffic-related toll occurs or fails to occur taking into account both the first messages as well as the messages of the third vehicle or third vehicles.

For example, the detection of the undershooting of a speed of 50 km/h by a first vehicle can be cancelled out by the detection of the exceeding of a speed of 50 km/h by a third vehicle.

In this respect, embodiments of the invention provide that the first vehicle or a plurality of first vehicles and the second vehicle each have a vehicle device with a sensor device, wherein the sensor device acquires in each case at least one measured value of a measurement variable which is representative of an exceptional traffic event, and the vehicle device compares the acquired measured value with a limiting value for this measurement variable, in order to detect the exceptional traffic event of the exceeding or undershooting of this limiting value by the measured value, and to generate data of this detection.

With such a vehicle device both first and second vehicles are enabled to evaluate a traffic event in a simple way to determine whether it is regular or irregular, in order to detect, where appropriate, an exceptional traffic event (braking maneuver, short inter-vehicle distance, stop, air pollution) as a function of the evaluation result. Features of the sensor device and of the processing of the measurement variables by the vehicle device are explained in more detail in conjunction with the description of the second aspect of the invention, the vehicle device according to the invention.

The method according to the invention preferably provides that the first vehicle and the second vehicle each have at least one sensor device (inter-vehicle distance sensor, speed sensor, acceleration sensor, particle sensor and/or pollutant sensor) which is functionally identical or structurally identical to that in the respective other vehicle and which acquires the respective comparable data of the same measurement variable (inter-vehicle distance, speed, acceleration, particle concentration, concentration of pollutants) which is representative of at least one predefined traffic situation. The method according to the invention preferably provides that the first detection by the first vehicle is produced as a result of a comparison of at least one measured value acquired by at least a first sensor device of the first vehicle of at least one first measurement variable which is representative of at least a first predefined traffic situation with a limiting value for the first measurement variable in the case of the event of the undershooting or the exceeding of the limiting value by the measurement value, and in the process data of the first detection is generated by the first vehicle, and the second detection by the second vehicle is produced as a result of a comparison of at least one measured value, acquired by at least a first sensor device of the second vehicle, of the first measurement variable with a limiting value for the first measurement variable in the case of the event of the undershooting or exceeding of the limiting value by the measured value, and in the process data of the second detection is generated by the second vehicle.

In particular, in this context data of the first detection comprises first event data which represents exceeding or undershooting of the limiting value of the measured first measurement variable, and data of the second detection comprises second event data which represents the exceeding of the limiting value of the measured first measurement variable.

In particular, data of the first detection comprise, in addition to the first event data, first chronological data and location data and data of the second detection in addition to the second event data comprise second chronological data and location data.

Developments of the method according to the invention can provide that the first detection by the first vehicle is produced as a result of a first comparison of the measured value, acquired by a first sensor device of the first vehicle, of a first measurement variable which is representative of at least a first predefined traffic situation with a first limiting value for the first measurement variable, and as a result of a second comparison of the measured value, acquired by a second sensor device of the first vehicle, of a second measurement variable which is representative of at least a second predefined traffic situation with a second limiting value for the second measurement variable in the case of the event of the undershooting or exceeding of the first limiting value by the first measured value, and the undershooting or exceeding of the second limiting value by the second measured value, and in the process data of the first detection by the second vehicle is generated, and the second detection by the second vehicle is generated as a result of a first comparison of the measured value, acquired by a first sensor device of the second vehicle, of the first measurement variable with a first limiting value for the first measurement variable and as a result of a second comparison of the measured value, acquired by a second sensor device of the second vehicle, of the second measurement variable with a second limiting value for the second measurement variable in the case of the event of the undershooting or exceeding of the first limiting value by the first measured value, and the undershooting or exceeding of the second limiting value by the second measured value, and in the process data of the second detection is generated by the second vehicle.

In particular, data of the first detection comprises first event data which represents exceeding or undershooting of the limiting value of the measured first measurement variable, and exceeding or undershooting of the limiting value of the measured second measurement variable, and data of the second detection comprises second event data which represents exceeding of the limiting value of the measured first measurement variable and exceeding or undershooting of the limiting value of the measured second measurement variable.

The first sensor device is preferably in each case a speed measuring device, and the first measurement variable is the vehicle speed and the second sensor device is in each case an inter-vehicle distance measuring device for measuring the inter-vehicle distance between the respective vehicle and a vehicle traveling ahead and/or behind, and the second measurement variable is the inter-vehicle distance between the respective vehicle and a vehicle traveling ahead and/or behind. Embodiments provide at least for the first vehicle that the method according to one or more embodiments comprises that the position of the first vehicle is repeatedly determined and, on the one hand, on the basis of one or more specific positions it is detected that the first vehicle is traveling along a route section which is subject to a traffic-related toll, and in the course of this identification a reporting mode of the first vehicle is activated in which the first vehicle is enabled to produce the first detection report and transmit data of the first detection report by radio and, on the other hand, it is detected on the basis of one or more specific positions that the first vehicle is traveling along a route section which is not subject to any traffic-related toll, and in the course of this detection the reporting mode of the first vehicle is deactivated, as a result of which at least the capability to transmit data of the first detection report is taken away from the first vehicle. In the case of the deactivated reporting mode, the capability of the first vehicle to produce the first detection is preferably cancelled.

In an equivalent way, it is alternatively or cumulatively possible to detect, on the one hand, the exiting of a route section which is not subject to any traffic-related toll, with the result that the reporting mode is activated, and on the other hand, the exiting of a route section which is not subject to a traffic-related toll is identified, with the result that the reporting mode is deactivated.

It is therefore possible to prevent detection reports being produced, or even data thereof being transmitted in regions which are not at all subject to a traffic-related toll. These regions can be freeway service stations and other car parks as well as city center areas which are equipped with light signaling systems (traffic lights). In these regions, stopping is possible not only on a traffic-related basis but also on a use-related basis.

It is possible to provide that the method according to the invention comprises radio reception of at least one second message which was generated by the second vehicle as a result of the second detection report, produced by the second vehicle, about the occurrence of an exceptional traffic event and was transmitted by radio, including data of the first detection report.

In this case, embodiments of the method according to the invention can also provide for the second vehicle that the position of the second vehicle is repeatedly determined, and, on the one hand, by means of one or more determined positions it is detected that the second vehicle is traveling along a route section which is subject to a traffic-related toll, and in the course of this detection a reporting mode of the second vehicle is activated, in which the second vehicle is enabled to produce the second detection report and to transmit data of the second detection report by radio, and, on the other hand, by means of one or more determined positions it is detected that the second vehicle is traveling along a route section which is not subject to any traffic-related toll, and in the course of this detection the reporting mode of the second vehicle is deactivated, as a result of which at least the capability to transmit data of the second detection report is removed from the second vehicle. In the case of the deactivated reporting mode, the capability of the second vehicle to produce the second detection report is also preferably switched off.

In order to detect the magnitude of the exceptional traffic situation, embodiments of the invention provide that the data processing comprises: a) the collection of a plurality of first messages with chronological data of first detection reports of a plurality of first vehicles, b) the counting of first messages the chronological data of which lies within a predefined time frame, c) the determination of a parameter which depends on the number of counted first messages, and d) the detection of a toll-incurring traffic situation on the basis of the comparison of the parameter with a predefined threshold value if the comparison reveals that the parameter exceeds or undershoots the predefined threshold value, wherein the collection of the traffic-related toll fee takes place only when the toll-incurring traffic situation which exceeds a predefined minimum magnitude of the exceptional traffic situation is detected. In this context, the second detection report of the second vehicle can also be included in the collection, counting, determination of parameters and detection of the toll-incurring traffic situation.

This produces a comprehensible method for assessing the magnitude of the exceptional traffic situation, by which method first messages have been transmitted by the first vehicles. Spontaneous, individually received first messages can relate to small, local, exceptional traffic situations which can break up again quickly and can bring about a chain of further first messages. Such insignificant events should not cause a toll to be collected. Relatively large exceptional traffic situations which build up within said time period and give rise to an accumulation of a multiplicity of first messages within said time frame should, on the other hand, cause tolls to be collected for the vehicles for which involvement in these exceptional traffic situations has also been detected or which have detected their involvement therefrom.

In the simplest case, the parameter is linearly dependent on the number of the first messages received within the predefined time frame. Non-linear dependencies are also possible.

It is also possible to provide a plurality of parameters, a plurality of time frames and/or a plurality of threshold values, in order to collect, depending on the parameter, time frame and/or threshold value, another toll fee or further toll fee which allows for different traffic densities, lengths of traffic jam and/or traffic jam times.

For example, the number of first detection reports of first vehicles which correspond to an exceptional traffic event can be combined with the number of third detection reports of third vehicles which correspond to a regular traffic event. The length of a traffic jam is in fact reduced if third vehicles arranged at the start of the traffic jam start to move again.

The reception of the first message or of a plurality of first messages and/or their processing can be carried out in a decentralized fashion in the second vehicle or centrally in a central data processing unit. In the first case, short-range car-to-car communication, for example DSRC (dedicated short-range communication) is used to transmit messages from vehicle to vehicle. In the second case, in order to transmit messages from a vehicle to the control center, for example, long-range mobile radio communication is used. Possible but less preferred is also DSRC communication with road-side devices which at least temporarily have a data connection to a central data processing unit. Corresponding communication devices and processors are for this purpose provided in the first and second vehicles and, if appropriate, in a control center.

The following embodiments allow for these different implementations.

With respect to the decentralized reception and the decentralized processing, embodiments of the invention provide that the data processing of the first message and of the second detection report is carried out by a processor which is included in a vehicle device of the second vehicle and is coupled in terms of data technology to a radio receiver device of the second vehicle in order to receive the first message.

This provides a simple possible way of receiving and processing the first messages at the location at which they can develop their possible toll-collecting effect. The limited range of a short-range car-to-car communication advantageously partially brings about the required causal relationship between the first detection report and the second detection report.

In this context, the mere reception of first messages according to the invention does not yet cause a toll to be collected. This continues to be dependent on the second detection report of an exceptional traffic event of the second vehicle because, of course, it may be the case that the second vehicle receives only first messages about an exceptional traffic event which is occurring on the oncoming roadway or a parallel road and in which the second vehicle is not involved.

In order to avoid traffic-related collection of a toll, which is based on an exceptional traffic event of the oncoming roadway or of a parallel road, for a second vehicle which detects an individual exceptional traffic event relating only to the second vehicle, there is provision according to the invention to check for similarity between at least data of the first detection report and data of the second detection report. In this context, this data must be suitable to permit the necessary differentiation between toll-determining vehicle groups on roadways running in opposite directions or different parallel roads. These can in turn be identification data of route sections of these roadways or parallel roads which were determined elsewhere on the basis of the driving profile of the vehicles and/or angle data of the direction of travel.

If the decentralized data processing of the first messages in the second vehicle, which has also detected the exceptional traffic event, results in the collection of a toll fee, this collection can be carried out in a decentralized fashion in the second vehicle or centrally in a central data processing unit. In the first case, the collection can be carried out by the vehicle device which receives and processes the first messages, the device being in the second vehicle.

For example, the collection of a traffic-related toll fee for the second vehicle, which is brought about by the result of data processing of data of the first detection report and of the second detection report, can be carried out by subtracting a toll fee amount from an electronic toll credit of a toll credit data memory which is included in the vehicle device of the second vehicle, or by adding a toll fee amount to an electronic total toll liability of a total toll liability data memory which is included in the vehicle device of the second vehicle.

The second case relates to embodiments of the invention according to which transmission, brought about by the result of the data processing of data of the first detection report and of the second detection report, of an instruction for the collection of a traffic-related toll fee from the vehicle device of the second vehicle is carried out via a mobile radio link between the vehicle device of the second vehicle and a central data processing unit of the toll system to the central data processing unit for the collection of the transferred, traffic-related toll fee, relating to the first vehicle and/or the second vehicle, by the central data processing unit.

With respect to the central reception and the central processing, embodiments of the invention provide that the data processing is carried out by a processor which is included in a central data processing unit of the toll system or formed thereby and is coupled in terms of data technology to at least a first radio receiver device to receive the first message and a second message which was generated by the second vehicle owing at least to the second detection report made by the second vehicle, including data of the second detection report, and was transmitted by radio.

In this context, the required spatial causal relationship of first messages received in a limited time frame is preferably produced in that the first messages and the second message each comprise the identifiers of route sections on which the respective vehicle has detected the exceptional traffic event. Identifiers of the same route sections and route sections which are directly adjacent to one another, insofar as these correspond in terms of the time sequence of the detection of their exceptional traffic events to an extent of the underlying exceptional traffic situation from a second route section to a first route section which precedes the second route section, indicate in this context a spatial causal relationship between the messages about the detection of an exceptional traffic event.

The transmission of the messages preferably occurs via a mobile radio network between the vehicles and the central data processing unit.

In this method it is to be considered advantageous compared to the prior art that the mobile radio network is not loaded by the periodic transmission of messages for the centralized detection of an exceptional traffic event but instead is only loaded to a significantly reduced extent in comparison therewith by the event-related messages, with respect to which the exceptional traffic event was detected in a decentralized fashion.

That is to say the mobile radio network (generally any communication network in which there is a connection to the control center) is not continuously loaded but instead according to the invention is loaded only when there is actually a reason to do so.

Advantageous developments of these embodiments provide that the first message and the second message are each transmitted to the central data processing unit via a mobile radio link, an instruction, brought about by the result of the data processing of the first messages, for the collection of a traffic-related toll fee by the central data processing unit via a mobile radio link between the central data processing unit and the second vehicle is transmitted to the second vehicle, and the transferred, traffic-related toll fee is collected by a vehicle device of the second vehicle.

The collection of tolls, in particular the collection of a traffic-related additional toll in addition to a basic fee which was unrelated to the traffic and which was already collected at the vehicle device of the second vehicle independently of the communication with a central data processing unit can be limited to the vehicle device of the second vehicle. A signal which is generated in conjunction with this traffic-related collection of the toll informs the driver of the second vehicle correspondingly under close to real time conditions. Deduction of a fee from a pre-paid credit, carried by the vehicle device of the second vehicle, if appropriate, possibly anonymously, is therefore also possible for the toll which is collected on a traffic-related basis.

It is particularly advantageous if during the time period between the transmission of the second message from the second vehicle to the central data processing unit and the transmission of the toll collection instruction or a message to the effect that the transmission of a toll collection instruction from the central data processing unit to the second vehicle does not occur, the mobile radio link between the second vehicle and the central data processing unit is maintained uninterruptedly.

It therefore becomes possible to encrypt, and keep secret, the identity of the second vehicle with respect to the central data processing unit, and to satisfy possible data protection requirements.

According to a second aspect of the invention, a vehicle device for collecting a traffic-related toll fee for at least one vehicle which is part of a toll-determining group of a plurality of vehicles is proposed, wherein the vehicle device has a radio receiver device, is included in a second vehicle and is designed a) to produce automatically a detection report about the occurrence of an exceptional traffic event, b) to receive at least a first message from at least a first vehicle via the radio receiver device, c) to compare with one another data items of the first message and of the detection report in the course of data processing of these data items, d) when a similarity between the data items is determined within a predefined scope to detect an assignment of the first vehicle and of the second vehicle to the toll-determining group, and e) as a result i) to collect a traffic-related toll fee relating to the second vehicle and/or ii) to transmit an instruction for the collection of a traffic-related toll fee relating to the first vehicle and/or to the second vehicle to a central data processing unit via a radio transmitter device. The vehicle device is designed, in particular, to generate the data items of the detection report as a result of the production of the detection report.

This aspect of the invention is completely advantageous in variant i) alone without a central device which could be involved in the processing of the first messages and/or the determination of tolls for the second vehicle. In an EETS scenario (EETS=European Electronic Toll Service) according to the Guideline 2004/52/EC of Apr. 29, 2004, about the interoperability of electronic road toll systems, a toll service provider could make available a computer program for processing the first messages for each on-board unit (OBU) which is suitable for toll collection and has means for car-to-car communication (for example by downloading via the mobile radio network if the OBU has means for mobile radio communication), in order to carry out the collection of traffic-related toll fees for each toll operator or another toll service provider.

In the variant ii) it becomes possible to bring about collection of a toll fee for another vehicle (the first vehicle) as the driver's own vehicle (the second vehicle) or for the driver's own, second vehicle by transmitting a corresponding collection request, for example via a mobile radio network, to a central data processing unit.

A mixed form is also conceivable in which a traffic-related toll relating to the second vehicle is collected in a decentralized fashion in the vehicle device of the second vehicle and an instruction to collect a traffic-related toll fee relating to the first vehicle is issued to the central data processing unit. If a vehicle device which is included in a first vehicle behaves in the same way by collecting a traffic-related toll fee relating to the first vehicle and transmitting an instruction for the collection of a traffic-related toll fee, relating to the second vehicle, to the central data processing unit, an effective central control of traffic-related toll fees which are collected in a decentralized fashion can advantageously take place.

Embodiments of the vehicle device according to the invention provide that the vehicle device comprises a radio transmitter device, in particular a communication device which comprises the radio receiver device and such a radio transmitter device combined, with which communication device it emits a second message with data of the detection report, which is received by other vehicles—for example also first vehicles—and is used by the other vehicles to determine a traffic-related toll fee relating to it.

In particular, data of the detection report is related to the exceeding or undershooting of the limiting value. A data record of the second message preferably contains a binary flag which characterizes exceeding by “1” and undershooting by “0” (or vice versa). When a plurality of limiting values are present, the second message additionally contains preferably a data element which represents a specific limiting value or makes said limiting value identifiable. Such a data structure can also be provided for the first messages.

Embodiments of the vehicle device according to the invention provide that the vehicle device comprises a sensor device which acquires at least one measured value of at least one measurement variable which is representative of a predefined traffic situation, and the vehicle device is designed to compare the measured value of the acquired measurement variable with a limiting value for this measurement variable, in order to produce the detection report about the occurrence of an exceptional traffic event on the basis of this limiting value being exceeded or undershot by the measured value, and to generate data of this detection report.

With such a sensor device it is possible that the vehicle device checks the second vehicle and/or its surroundings to determine whether an exceptional traffic event is occurring. According to the invention this is initially just an individual exceptional traffic event which relates to the second vehicle and which, without at least one first message from a first vehicle, does not yet have to be representative of a toll-incurring traffic situation. According to the invention, only a plurality of detection reports about an exceptional traffic event give rise to an exceptional traffic situation which involves a plurality of vehicles and which can entail a toll liability.

The sensor device can serve to acquire measurement variables for the movement of the second vehicle with respect to itself (speed, acceleration during braking maneuvers, stationary period) measurement variables the position of the second vehicle with respect to other vehicles—for example the first vehicle—(inter-vehicle distance) or measurement variables for the state of the surroundings of the second vehicle (concentration of pollutants) and to detect, by a comparison of a corresponding measured value for at least one of these measurement variables with a limiting value, whether an exceptional traffic event relating to the second vehicle (reduced speed, severe braking maneuver, relatively long stop, short inter-vehicle distance from a vehicle traveling ahead or behind, increased concentration of pollutants) is occurring.

To this extent, embodiments of the invention provide in this respect that the sensor device comprises at least one or more of the following measuring devices or is formed by at least one of the following measuring devices: at least one speed measuring device, at least one inter-vehicle distance measuring device, at least one stationary period device and at least one concentration of pollutants measuring device.

Embodiments of the invention therefore provide that the sensor/measuring device measures the speed of the vehicle and the vehicle device is designed, given undershooting of a minimum speed, to detect the exceptional traffic event of a possible exceptional traffic situation which influences the speed of the vehicle and/or, given exceeding of a recommended speed, to detect the exceptional traffic event of the possible breaking-up of the exceptional traffic situation.

For the measurement of the speed it is possible to use as a sensor device a tachometer which receives from an incremental signal transmitter pulses of a vehicle tire, the frequency of which pulses is proportional to the vehicle speed. Alternatively or optionally, for the measurement of the speed it is possible to use as a sensor device a GNSS receiver which calculates the speed of the vehicle from the satellite signals of a global navigation satellite system (GNSS) which it receives.

Alternatively or optionally with respect to a sensor/measuring device which measures the speed, embodiments of the invention provide that the sensor/measuring device measures an inter-vehicle distance of the vehicle from a vehicle traveling ahead and/or behind, and the vehicle device is designed, given undershooting of a minimum inter-vehicle distance, to detect the first limiting value signal and/or, given exceeding of a standard inter-vehicle distance, to detect the second limiting value signal of the exceptional traffic event of a possible exceptional traffic situation which influences the inter-vehicle distance from a vehicle traveling ahead and/or behind.

For the measurement of the inter-vehicle distance it is possible to use as a sensor/measuring device a radar measuring unit which measures the distance from the object by means of a transit time measurement of the wave (light, microwave, ultrasound) which is emitted and reflected at the distant object. Alternatively or optionally, the passive autofocus measurement of a camera can be used as sensor device for measuring the inter-vehicle distance, said camera operating with the contrast and/or phase comparison method.

Alternatively or optionally with respect thereto, embodiments of the invention provide that the sensor/measuring device measures acceleration of the vehicle, and the vehicle device is designed, given exceeding of the value of a negative of a minimum acceleration value of a braking maneuver, to detect the exceptional traffic event of a possible exceptional traffic situation which influences the braking behavior inter-vehicle distance from the vehicle traveling ahead and/or vehicle traveling behind.

For the measurement of the acceleration it is possible to use an acceleration sensor of an airbag sensor type.

Alternatively or optionally with respect thereto, embodiments of the invention provide that the sensor/measuring device measures a stopping period of the vehicle, and the vehicle device is designed, given exceeding of a minimum stopping period, to detect the exceptional traffic event of a possible exceptional traffic situation which blocks progress.

In order to measure the stopping period, a speed sensor (see above) or an inter-vehicle distance sensor (see above) is used in conjunction with a clock.

For this purpose, the processor of the vehicle device according to the invention can be designed to compare a first acquired measurement variable with a first limiting value for this first measurement variable, in order to produce the detection report about the occurrence of an exceptional traffic event on the basis of the undershooting of this first limiting value, and to generate data of a first detection report, and to compare a second acquired measurement variable with a second limiting value for this second measurement variable, in order to produce the detection report about the occurrence of an exceptional traffic event on the basis of the exceeding of this second limiting value, and to generate data of a second detection report, wherein the second limiting value is greater than the first limiting value.

In the case of the measurement of speed, the first limiting value can be 30 km/h, and the second limiting value 60 km/h. Undershooting of 30 km/h corresponds to a stop or to slowly moving traffic; exceeding of 60 km/h corresponds to the resumption of freely flowing traffic.

In the case of the inter-vehicle distance measurement, the first limiting value can be 20 m and the second limiting value 40 m. Undershooting of 20 m corresponds to a stop or to slowly moving traffic; exceeding of 40 m corresponds to the resumption of freely flowing traffic.

Alternatively or optionally with respect thereto, embodiments of the invention provide that the sensor/measuring device measures the concentration of at least one pollutant in the air surrounding the vehicle, and the vehicle device is designed, given exceeding of a maximum concentration of this pollutant, to detect the first limiting value signal and/or given undershooting of a recommended concentration of this pollutant, to detect the second limiting value signal of an exceptional traffic event of an exceptional traffic situation which influences the concentration of pollutants in the surrounding air negatively or positively.

Such pollutants may be: carbon dioxide, carbon monoxide, ozone, nitrous oxides (in particular NO₂), sulfur oxides (in particular SO₂) and fine dust.

Measuring devices for the speed, inter-vehicle distance, acceleration, stopping period and/or concentration of pollutants may be included in the same sensor device or in different sensor devices which are structurally separate from one another and which each have a data connection to a processor of the vehicle device. If a plurality of measuring devices which are different or of the same type are provided in the vehicle device, it is preferably sufficient for one of the measurement variables of the measuring devices to exceed or undershoot a limiting value related thereto for the vehicle device to be able to detect the exceptional traffic event. However, instead, in order to make the detection of the exceptional traffic event less susceptible to faults, it can also be provided to make the detection of the exceptional traffic event dependent on whether a plurality of measurement variables of measuring devices which are different and/or of the same type exceed or undershoot a limiting value relating thereto.

Embodiments of the invention provide that the vehicle device comprises one or more of the said measuring devices for measuring two first and second measurement variables which follow one another at a time interval, and the vehicle device is designed to compare at least the first measurement variables with the limiting value relating thereto, in order, in the event of the first measurement variables exceeding or undershooting a first limiting value, to transmit a first signal, corresponding to the detection of a first exceptional traffic event, to the central data processing unit, and in the event of the second measurement variable exceeding or undershooting a second limiting value, to transmit a second signal, corresponding to the detection of a second exceptional traffic event, to the central data processing unit.

For example, the exceeding of the first limiting value can correspond to a first exceptional traffic event representing increased traffic loading, and the undershooting of the second limiting value can correspond to a second exceptional traffic event, representing reduced traffic loading. First and second signals can be processed in the central data processing unit, in order to generate, as a function of the result of the processing, an instruction to collect or not to collect a traffic-related toll fee.

It can be provided that the vehicle device comprises a radio transmitter device (for example in that the radio receiver device is designed as a radio transceiver device) and is designed to generate data of the detection report and to transmit this data within the scope of a second message by means of the radio transmitter device.

It is irrelevant in this case whether the detection report, the generation of data or the transmission of messages takes place before the reception. The vehicle device according to the invention is preferably designed to be able to carry out the comparison of data items of the first message both with data items of a detection report which were generated before the reception of the data items of the first message as well as with data items of a detection report which were generated after the reception of the data items of the first message.

According to embodiments of the vehicle device according to the invention, the vehicle device according to the invention comprises a position-determining device which is designed to determine repeatedly—for example on the basis of data received by a GNSS receiver from satellites of a global satellite navigational system (GNSS)—positions of the vehicles, wherein the vehicle device is designed to detect, on the basis of one or more determined positions, the travel along a route section which is subject to a traffic-related toll, and in the course of this detection to activate a reporting mode of the vehicle device in that the vehicle device is enabled to produce the detection report and to receive the first message, and, on the other hand, to detect, on the basis of one or more determined positions, the travel along a route section which is not subject to any traffic-related toll, and in the course of this detection to deactivate the reporting mode of the vehicle device, as a result of which at least the capability of the vehicle device to receive messages of the type of the first message is suppressed.

The activation of the reporting mode preferably additionally brings about the enablement of the vehicle device to transmit a second message with data of the detection report, and the deactivation of the reporting mode additionally brings about suppression of the capability of the vehicle device to transmit a second message with data of the detection report.

According to a third aspect of the invention, a central data processing unit for collecting a traffic-related toll fee for at least one vehicle which is part of a toll-determining group of a plurality of vehicles is designed, a) to receive at least one first message, which is triggered in relation to traffic and transmitted by radio, from at least one first vehicle, b) to receive at least one second message, which is triggered in relation to traffic and transmitted by radio, from at least one second vehicle, and c) to process the first message and the second message, in order to generate an instruction for the collection of a traffic-related toll fee for the second vehicle if a comparison, which has taken place in the course of the data processing, of data of the first message and of the second message reveals a similarity of data of the first message with data of the second message within a predefined scope, as a result of which the first vehicle and the second vehicle are assigned to the toll-determining group of vehicles.

Although this aspect of the invention requires a central device, it advantageously does not require additional means for car-to-car communication in the vehicle devices. Therefore, it is also possible to use vehicle units (OBUs) for the collection according to the invention of a traffic-related toll which have just one mobile radio communication device but do not have a car-to-car communication device.

In an EETS scenario (EETS=European Electronic Toll Service) according to the Guideline 2004/52/EC of Apr. 29, 2004 about the interoperability of electronic road toll systems, a toll service provider which has said central data processing unit could make available a computer program for processing the sensor measured values, for transmitting messages about the detection of an exceptional traffic event and for receiving a toll collection instruction from a central data processing unit for any on-board unit (OBU) which is suitable for collecting tolls and which has means for mobile radio communication, for example by downloading via the mobile radio network, in order to carry out the collection of traffic-related toll fees for any toll operator or for another toll service provider.

Therefore, a central data processing unit is provided which is capable of imposing on a second vehicle a traffic-related toll by virtue of the second vehicle being involved in a toll-liable traffic situation, wherein the toll-liable traffic situation is detected by the central data processing unit on the basis of the first messages from first vehicles which are involved in the toll-liable traffic situation, and involvement of the second vehicle in the toll-liable traffic situation is detected on the basis of the second message of the second vehicle.

Alternatively or optionally with respect to the transmission of an instruction to collect the traffic-related toll fee to the second vehicle it is possible to provide that the central data processing unit adds the traffic-related toll fee to a centrally stored data record of toll fees of the second vehicle. However, for this purpose the identity of the second vehicle or of a vehicle device which is carried along by the second vehicle and which transmits the second message must be communicated together with the second message.

It is advantageously possible to dispense with making the identity of the second vehicle known for the sake of data protection if the data processing unit is designed to maintain the mobile radio link to the second vehicle after the reception of the second message, and not to end said link until the data processing unit has transmitted to the second vehicle said instruction or a message to the effect that no such instruction is being issued. In this respect, embodiments of the central data processing unit according to the invention provide that the data processing unit is designed a) to receive the first message of the first vehicle via the mobile radio link between the first vehicle and the central data processing unit, b) to receive the second message of the second vehicle via a mobile radio link between the second vehicle and the central data processing unit, and c) to maintain the mobile radio link to the second vehicle after the reception of the second message, and not to end said link until the data processing unit has transmitted to the second vehicle said instruction or a message to the effect that no such instruction is being issued.

Finally, a toll system according to the invention consists in comprising a plurality of vehicle devices according to the invention which are distributed among different vehicles, and/or at least one central data processing unit according to the invention and/or in being designed to carry out a method according to the invention.

### BRIEF DESCRIPTION OF THE DRAWINGS

The invention will be explained in more detail below with reference to three exemplary embodiments. In respect of which,

FIG. 1 shows, with FIG. 1a, a column of vehicles according to a first and a second exemplary embodiment, which are traveling on a road, and with FIG. 1b an inventive toll-determining group of vehicles, formed from this column, according to the first and second exemplary embodiments,

FIG. 2 shows a vehicle device according to the invention according the first and second exemplary embodiments,

FIG. 3 shows the flowchart for the sequence of the method according to the invention of the first exemplary embodiment on the vehicle device according to the invention,

FIG. 4 shows the flowchart for the sequence of an inventive method according to the second exemplary embodiment on the vehicle device according to the invention,

FIG. 5 shows, with FIG. 5a, a column of vehicles according to a third exemplary embodiment which are traveling on a road, and with FIG. 5b an inventive toll-determining group of vehicles, formed from this column together with further vehicles, according to the third exemplary embodiment,

FIG. 6 shows an inventive vehicle device according to the third exemplary embodiment,

FIG. 7 shows an inventive toll system according to the third exemplary embodiment,

FIG. 8 shows the flowchart of a method according to the invention according to the third exemplary embodiment,

FIG. 9a shows a first graphic illustration of inventive messages, received in the course of a time frame, according to the third exemplary embodiment,

FIG. 9b shows a second graphic illustration of the inventive messages, received in the course of the time frame, according to the third exemplary embodiment,

FIG. 9c shows a first graphic illustration of a first toll parameter formed in the course of the time frame and

FIG. 9d shows a second graphic illustration of a second toll parameter formed in the course of the time frame.

### DETAILED DESCRIPTION

### First Exemplary Embodiment

### Decentralized Toll Detection for Another Vehicle

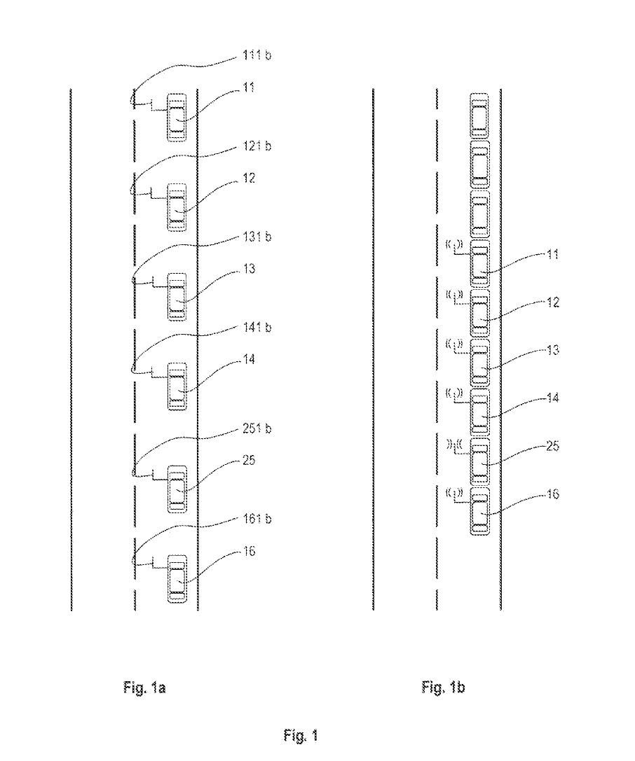

The inventive collection of a traffic-related toll fee will be presented with the first exemplary embodiment with reference to FIGS. 1, 2 and 3 and on the basis of a decentralized toll detection, relating to a first vehicle, on a vehicle device 250 of a second vehicle 25.

A plurality of first vehicles 11, 12, 13, 14 and 16 are equipped with vehicle devices which are each assigned to the respective vehicles 11, 12, 13, 14 and 15 and vehicle devices which are each assigned to the respective vehicles 11, 12, 13, 14 and 16 and which each have a short-range vehicle-to-vehicle communication device (car-to-car communication device), the transmitting and receiving antennas 111 b (vehicle 11), 121 b (vehicle 12), 131 b (vehicle 13) 141 b (vehicle 14) and 161 b (vehicle 16) of which are illustrated schematically and not to scale in FIG. 1a.

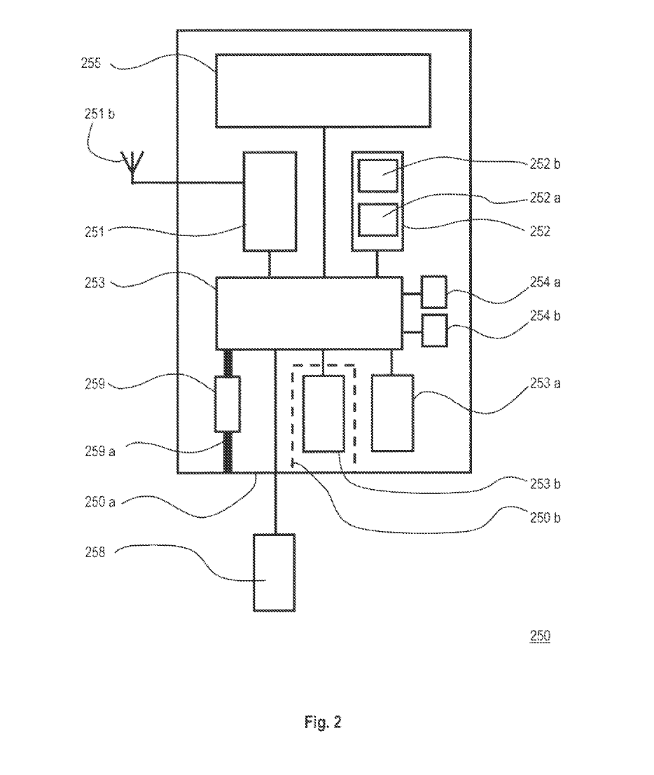

A second vehicle 25 is equipped with a vehicle device 250 which is illustrated in FIG. 2 and comprises a vehicle-to-vehicle communication device 251 with a transmitting and receiving antenna 251 b (FIG. 1a, FIG. 2). The vehicle device 250 according to FIG. 2 additionally comprises within its housing 250 a, a processor 253 which is coupled in terms of data technology to the car-2-car communication device 251 and has data-transmitting communication connections to an inter-vehicle distance sensor 252, a clock 254 a, a compass 254 b, a program and operating data memory 253 a and a display device 255 for reproducing data in text form and/or graphic form. These components are, like the processor, supplied with electrical energy via a battery 259 which can itself be electrically recharged via a terminal 259 a.

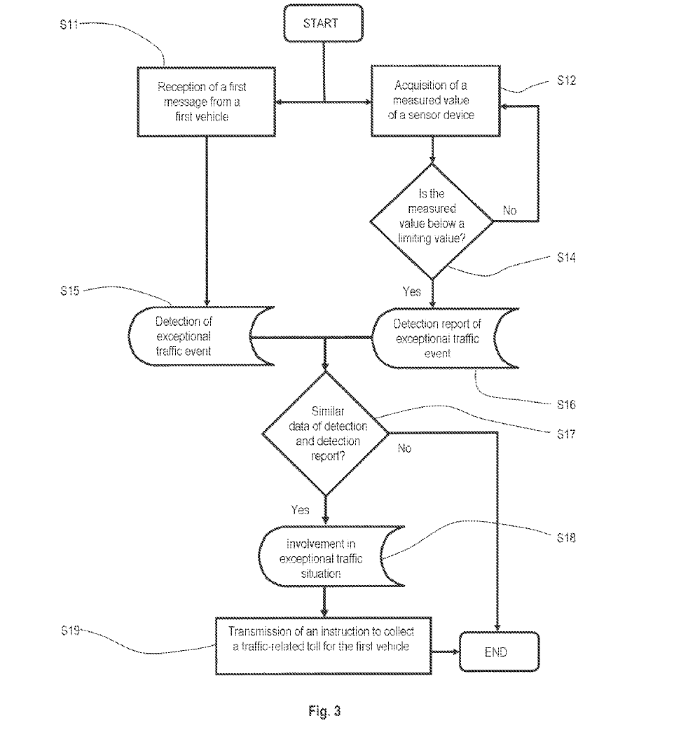

The toll fee data memory 253 b which is illustrated in FIG. 3 and is held in a removable fashion in the form of a memory card by a receptacle recess 250 b of the housing 250 a, is not a subject matter of this first exemplary embodiment because this first exemplary embodiment provides central collection of tolls for another (first) vehicle than for the second vehicle equipped with the vehicle device described here. The toll fee data memory 253 b which is illustrated in FIG. 3 and is held in a removable fashion in the form of a memory card by a receptacle recess 250 b of the housing 250 a is instead a subject matter of the second exemplary embodiment (see there).

In addition, a tachograph 258, which is arranged outside the housing 250 a, is part of the vehicle device 250. It periodically transmits, in a cycle of seconds, speed signals to the processor 253 while the inter-vehicle distance sensor 252 periodically transmits in a cycle of seconds inter-vehicle distance signals to the processor 253, which signals represent the distance between the second vehicle 25 and the first vehicle 14 traveling ahead, insofar as the first vehicle 14 is in the radiation range of the ultrasonic sender 252 a of the inter-vehicle distance sensor 252 and reflects back the ultrasound emitted by the ultrasonic sender 252 a of the inter-vehicle distance sensor 252 into the reception range of the ultrasonic receiver 252 b of the inter-vehicle distance sensor 252, and otherwise the inter-vehicle distance sensor transmits to the processor a signal which represents the absence of a vehicle traveling ahead in the detection range of the inter-vehicle distance sensor.

The sequence of the collection of tolls in this exemplary embodiment on the vehicle device 250 is illustrated in FIG. 3.

The processor 253 is configured to load a corresponding computer program from the program and operating data memory 253 a into its main memory (not illustrated), to receive measured values of the vehicle speed from the tachometer 258 (S12 in FIG. 3) and to compare these measured values with a limiting value of the vehicle speed (S14 in FIG. 3) which is 50 km/h, in order to automatically detect, in the event of undershooting of this limiting value by one of the measured values, the occurrence of an exceptional traffic event for the second vehicle 25 (S16 in FIG. 3) and to generate in respect thereof a first data record which comprises data elements A, B, C and D, of which A represents the traffic event justification of the undershooting of the limiting speed, B represents a time of the detection report which is received by the clock 254 a, C represents an angular orientation of the second vehicle 25 with respect to a reference direction, received by the compass 254 b, and D represents information as to the fact that this detection report was produced by the second vehicle, and to store this first data record in the program and operating data memory 253 a.

The processor 253 is also configured to receive measured values of a distance of a vehicle traveling ahead from the inter-vehicle distance sensor 252 (S12 in FIG. 3) and to compare these measured values with a limiting value of the inter-vehicle distance (S14 in FIG. 3) which is 20 m, in order, given undershooting of this limiting value by one of the measured values, to detect automatically the occurrence of an exceptional traffic event for the second vehicle 25 (S16 in FIG. 3) and to generate in this respect a second data record which comprises data elements A, B, C and D, of which A represents the traffic event justification of the undershooting of the inter-vehicle distance, and B, C and D represent the abovementioned information, and to store this second data record in the program and operating data memory.

Alternatively or optionally, the first and/or second data records can also be stored in the main memory. In addition, the processor 253 is configured to instruct the car-2-car communication device 251 to transmit the first or the second data record in the radio mode once or, if appropriate, periodically every 5 seconds repeatedly (with the addition of a data element E which represents the number of the transmission repetition) within a predefined time frame of a minute. For this purpose, the processor is configured to transmit the first and/or the second data record to the car-2-car communication device 251.

The vehicle devices (not illustrated) of the first vehicles 11, 12, 13, 14 and 16 are at least functionally identical to the vehicle device 250 of the second vehicle 25; and they are preferably structurally identical. Their processors are designed to receive, process and store data in the same or an analogous fashion and to transmit it via the car-2-car communication devices, like the processor 253 of the vehicle device 250 of the second vehicle 25.

The processor 253 is, furthermore, designed to receive from the first messages, received from the car-2-car communication device 251, from one or more of the first vehicles 11, 12, 13, 14 and 16 (S11 in FIG. 3), as a result of which the processor 253 detects the involvement of the first vehicles in an exceptional traffic event and detects the latter as such (S15 in FIG. 3), and to store said messages in the program and data memory 253 a. These messages comprise one or more data records of the type of the first or second data record generated automatically by the vehicle device 250. The received data records can be differentiated, in terms of their origin, from one of the first vehicles 11, 12, 13, 14 or 16 on the basis of the data elements D.

The automatic generation of the first and/or second data records of the second vehicle 25, and the reception of first messages with analogue data records of vehicles of the first vehicles 11, 12, 13, 14 and 16 is possible if these first vehicles 11, 12, 13, 14 and 16 have detected in each case their involvement in an exceptional traffic event, such as the traffic jam illustrated in FIG. 1b, in a surrounding area which corresponds to the range of the car-2-car communication. Subsequently all of these vehicles each transmit a message about their detection with said data elements by means of their transmitting and receiving antenna 111 b, 121 b, 131 b, 141 b, 251 b and 161 b. Insofar as these vehicles are arranged in the surrounding area comprising the range of the car-2-car communication, they receive the messages of the respective other vehicles by means of their transmitting and receiving antennas 111 b, 121 b, 131 b, 141 b, 251 b and 161 b. Each vehicle here with respect to the other vehicles to which it transmits, with respect to a first vehicle and with respect to the vehicles from which it receives, with respect to a second vehicle.

In FIG. 1b, for reasons of clarity, only the transmission mode is illustrated here for the first vehicles 11, 12, 13, 14 and 16 and only the reception mode for the second vehicle 25.

In this case, the limited range of the car-2-car communication means that the vehicle device 250 of the second vehicle 25 only receives messages of the first vehicles 13, 14 and 16.

The processor 253 is designed to compare, triggered by the automatic generation of an event-dependent first or second data record relating to the second vehicle 25, triggered by the reception of a first message from one of the first vehicles 13, 14 and 16 and/or periodically at regular time intervals of 10 seconds, the data records of the second vehicle 25, which are stored in the program and operating data memory 253, with one or more data records of one or more first messages of one or more first vehicles 13, 14 and 16 (S17 in FIG. 3).

Here, the processor 253 is designed, in particular, to determine whether the time information of the data elements B of the data records are similar to one another in such a way that their time intervals with respect to one another are shorter than 30 seconds. Alternatively or optionally, the processor 253 is designed to determine whether the time information of the data elements B of the data records are similar to one another in such a way that their chronological values lie within a time frame of 1 minute. The processor 253 is therefore designed to detect, on the basis of the similarity of their data elements B, a chronological relationship between the event-triggered data records and to assign the respective vehicles to a toll-determining group of vehicles which are involved in the exceptional traffic situation (S18 in FIG. 3), and to provide their data records with a corresponding data element which represents this toll-determining group. In the present case, the chronological values of the data elements B 11:37:22 (vehicle 13), 11:37:38 (vehicle 14), 11:38:02 (vehicle 25) and 11:39:16 (vehicle 16). The processor 253 therefore assigns the vehicles 13, 14 and 25 to a toll-determining group.

In addition, the processor 253 is designed to delete data records whose time values lie in the past by longer than twice the predefined time frame of the recently input data record, that is to say lie in the past by longer than 2 minutes. This applies both to the data records of the first messages and to the data record generated specially with respect to the second vehicle.

The processor 253 is optionally designed to determine whether the angular information of the data elements C of the data records are similar to one another such that their angular intervals with respect to one another are less than 30 degrees. Alternatively or optionally, the processor 253 is designed to determine whether the angular information of the data elements C of the data records are similar to one another such that their angle values lie within an angle range of 60 degrees.

In the present case, the angles are 345° (vehicle 13), 347° (vehicle 14), 342° (vehicle 25) and 344° (vehicle 16) with respect to the northerly direction (0°).

The processor 253 is designed to detect, in addition to the previously detected chronological relationship, a spatial relationship of the event-triggered data records on the basis of the similarity of their data elements C, and to assign the respective vehicles 13, 14 and 25 to a toll-determining group and to provide their data records with a corresponding data element which represents this toll-determining group.

This may be necessary in order to prevent vehicles being assigned to events on the oncoming roadway in which they are not involved (S18 in FIG. 3).

Due to the positive result of the checking for a chronological and spatial relationship between the exceptional traffic events detected by the first vehicles 13 and 14 and the second vehicle 25, the processor carries out storage of the data records, provided with the data element of the toll detection, of the first vehicles 13 and 14 and the second vehicle 25 in the program and operating data memory 253 a, which data records are now considered to be toll data records of these vehicles.

According to the purpose of the first exemplary embodiment, the processor 253 is designed to initiate collection of tolls for those first vehicles whose assignment to a toll-determining group the processor 253 has implemented, in that the processor 253 is designed, by means of the car-2-car communication device which is embodied as a car-2-infrastructure communication device for DSRC (dedicated short-range communication), transmits (not illustrated) instructions for the collection of traffic-related toll fees, related to the first vehicles 13 and 14, via a road-side receiver device to a central data processing unit as soon as the second vehicle 25 has passed and detected such a unit (S19 in FIG. 3).

As an alternative to this, the vehicle device 250 comprises a mobile radio communication device (not illustrated), for the use of which the processor 253 is designed to transmit (not illustrated) instructions for the collection of traffic-related toll fees relating to the first vehicles 13 and 14 to a central data processing unit via a mobile radio network.

Owing to the data elements D which are also transmitted, the central data processing unit is able to determine the toll-liable vehicles 13 and 14 and to assign them to user accounts into which traffic-related toll fees are entered. The central data processing unit can be designed to collect traffic-related toll fees for a first vehicle only when said unit receives a plurality of similar instructions to collect a traffic-related toll, relating to the first vehicle 13 or 14, from a plurality of different second vehicles 25 and, for example, 12 (second vehicle relating to messages which vehicle 12 receives from vehicle 13 and/or 14). The associated data redundancy increases the probability of correct collection of a traffic-related toll fee.

This includes the possibility that the vehicle device 250 also transmits an instruction to collect a traffic-related toll to the second vehicle 25 (that is to say the driver's own vehicle) to the control center, which instruction is implemented on a central basis in terms of the collection of a toll relating to the second vehicle when at least a first vehicle 13, 14 or 16 has detected the involvement of the second vehicle in the traffic jam and has transmitted just such an instruction, relating to the second vehicle 25, to the control center, and vice versa.

The inventive collection of a toll is considered to have taken place with the central entry of the traffic-related toll fee into a user account which is linked to the first vehicle.

The processor 253 of the vehicle device 250 is designed to delete the toll data records stored in the program and operating data memory 253 a after the reception of a reception confirmation about the reception of the instructions from the road-side device and/or the central data processing unit.

Irrespective of this, the processor 253 of the vehicle device 250 is designed to delete the toll data records stored in the program and operating data memory 253 a after the expiry of a predefined storage time since their generation or the transmission of the toll collection instruction, for example after five minutes. This permits a data protection requirement to be satisfied.

### Second Exemplary Embodiment

### Decentralized Toll Detection for Driver's Own Vehicle

The inventive collection of a traffic-related toll fee relating to a second vehicle 25 is presented with the second exemplary embodiment with reference to FIGS. 1, 2 and 4 and with reference to a decentralized toll detection process, relating to the second vehicle 25, on a vehicle device 250 of the second vehicle 25.

In addition to the components of the vehicle device 250 which are presented under the description of the first exemplary embodiment, the vehicle device 250 also has a toll fee data memory 253 b which is held in a removable fashion in the form of a memory card by a receptacle recess 250 b of the housing 250 a.

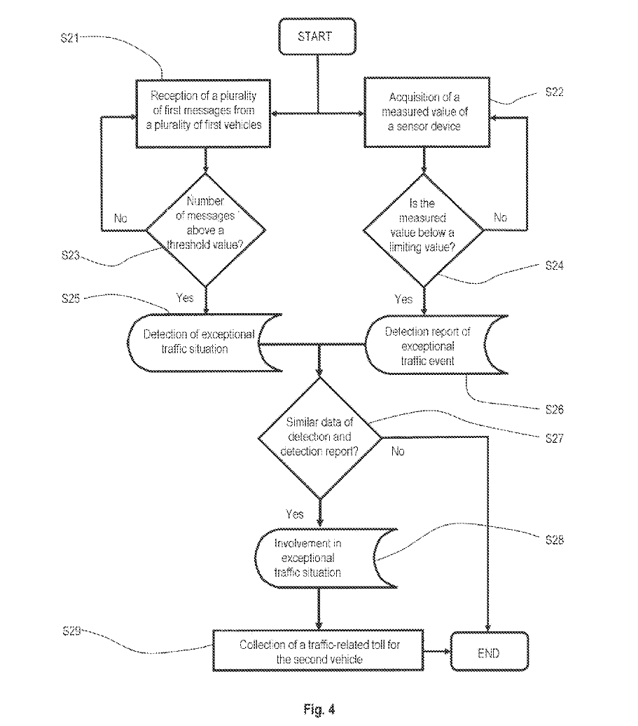

The processor 253 of the vehicle device 250 of the second vehicle is equipped with the same features up to the step S28 in FIG. 4 in which the toll-determining vehicle group is defined, and is designed to implement the same method steps as in the first exemplary embodiment. In addition to this, the processor 253 is designed to count the first messages, received in the method step S21, of the first vehicles 13, 14 and 16 over a predefined time frame of 2 minutes, which time frame extends in a retroactive fashion with each most recently received message. The reception time should in each case occur one second later than the chronological values, described in the first exemplary embodiment, of the data elements B. With the most recently received first message of the vehicle 16, the predefined time frame comprises the first messages of the vehicles 13, 14 and 16. The processor 253 is designed to compare (S23) the number of the counted received first messages (in this case: three) with a threshold value for the number of the received messages, which is two, in order to detect (S25) an exceptional traffic situation when this threshold value is exceeded. In the second exemplary embodiment, the number-related detection forms the precondition for the fact that the processor 253 enters at all into the phase of the comparative data element analysis with the data record of the detection of the second vehicle 25 by way of an exceptional traffic event relating to the second vehicle 25: without a minimum number of first messages (S25) it is just as much the case that the processor 253 will not arrive at this analysis step S27 as when the detection S26 of the second vehicle 25 does not occur. Necessary computational expenditure by the processor 253 is therefore prevented. The following comparison analysis corresponds to that of the first exemplary embodiment and accordingly ends with the determination of the group at vehicles 13, 14 and 25 which are involved (S28) in the exceptional traffic situation of the traffic jam.

For the execution of the following method step S29, the processor is designed, in contrast to the first exemplary embodiment, to access the toll data memory 253 b of the second vehicle 25 in order to subtract from the toll fee credit stored there, which was registered in the course of a prepayment procedure in the toll data memory 253 b in favor of the user, owner or holder of the second vehicle 25, a traffic-related toll fee which corresponds to the exceptional traffic situation, and therefore to reduce correspondingly the available toll fee credit.

As a result, according to the invention a traffic-related toll fee relating to the second vehicle 25 is collected after the situation-related toll liability of the second vehicle 25 has been detected in a decentralized fashion by the vehicle-mounted vehicle device 250 of the second vehicle 25.

### Third Exemplary Embodiment

### Central Toll Detection

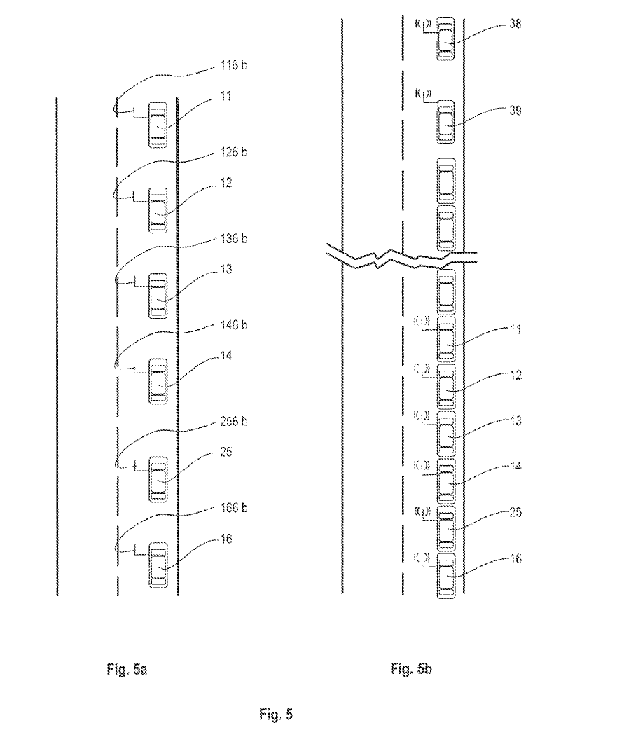

The inventive collection of a traffic-related toll fee relating to a second vehicle 25 will be presented with the third exemplary embodiment with reference to FIGS. 5, 6, 7 and 8 as well as 9a, 9b, 9c and 9d and with reference to a central toll detection process, relating to the second vehicle 25 at a central data processing unit 51 of a toll control center 50 within the scope of a toll system according to the invention.

For the processing of data, the central data processing unit 51 has at least one central processor (not illustrated) for storing data at least one central data memory (not illustrated). Alternatively, the central data processing unit 51 itself forms the central processor, and a central data memory (not illustrated) is connected to this central processor.

In contrast to the two preceding exemplary embodiments, not only first messages of first vehicles about the occurrence of a toll-incurring traffic event are included in the toll-determining decision relating to the second vehicle which has transmitted a second message to the control center but also third messages of third vehicles about the breaking-up of the toll-incurring traffic event.

A plurality of first vehicles 11, 12, 13, 14 and 16 are each equipped with vehicle devices which are assigned to the respective vehicles 11, 12, 13, 14 and 16 and each have a long-range vehicle-to-control center communication device in the form of a mobile radio communication device, the transmitting and receiving antennas 116 b (vehicle 11), 126 b (vehicle 12), 136 b (vehicle 13) 146 b (vehicle 14) and 166 b (vehicle 16) of which are illustrated schematically and not to scale in FIG. 5a.

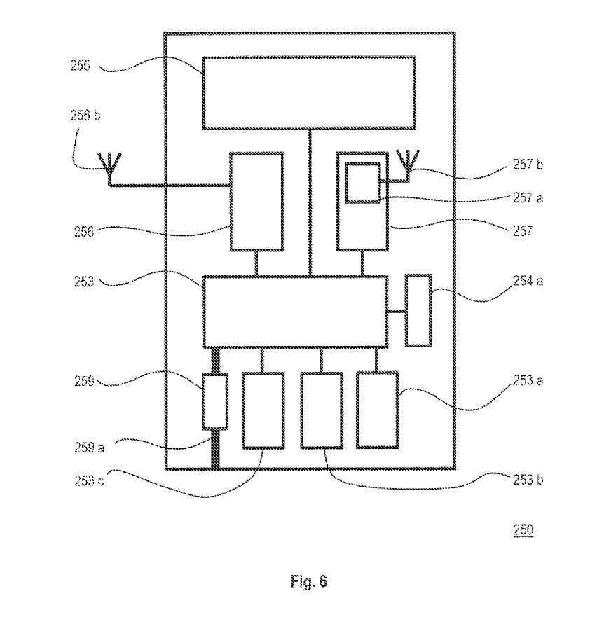

A second vehicle 25 is equipped with a vehicle device 250 which is illustrated in FIG. 6 and comprises a vehicle-to-control center communication device in the form of a mobile radio communication device 256 with a transmitting and receiving antenna 256 b (FIG. 5a, FIG. 6).

The vehicle device 250 also comprises according to FIG. 6 within its housing 250 a, a processor 253 which is coupled in terms of data technology to the mobile radio communication device 256 and data-transmitting communication connections to a GNSS position-determining device 257 (GNSS=Global Navigation Satellite System), a clock 254 a, a program and operating data memory 253 a, a toll data memory 253 b, a card data memory 253 c, which comprises a geographic database with toll objects assigned to location coordinates, and to a display device 255 for reproducing data in the form of text and/or in a graphic form. These components are, like the processor, supplied with electrical energy via a battery 259 which can itself be electrically recharged via a terminal 259 a.

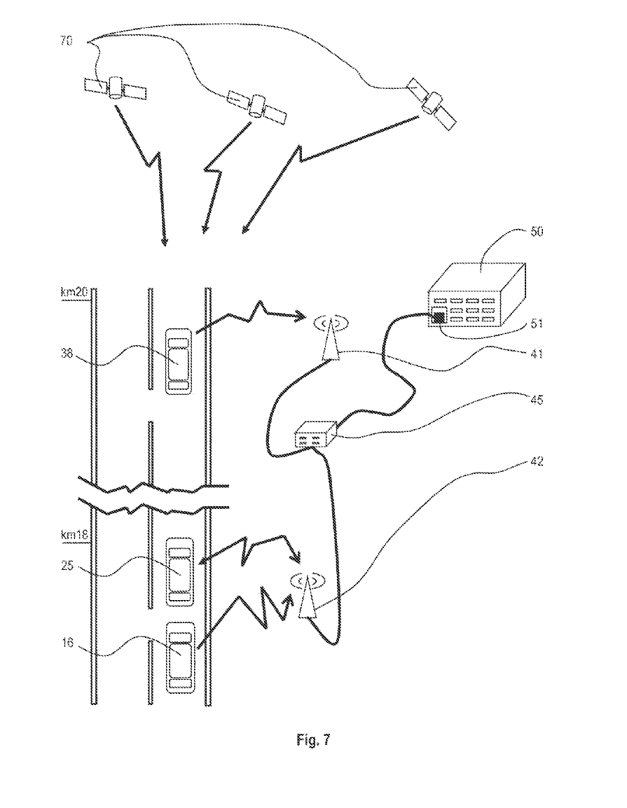

The GNSS position-determining device 257 receives signals from position-determining satellites 70 (FIG. 7) by means of its GNSS receiver 257 via a GNSS receiver antenna 257 b, and processes said position-determining signals 70 periodically with a clock cycle of a second with respect to current position information of the vehicle 25 in the form of position data and with respect to a first speed information item of the vehicle 25 from the Doppler frequency shift of the GNSS signals and to a second speed information item of the vehicle 25 from the difference of the most recently obtained position data and the most recently obtained position data relating to the time interval between the two.

The processor 253 is configured to load a corresponding computer program from the program and operating data memory 253 a into its main memory (not illustrated), to regularly receive position data of the GNSS position-determining device 257 and to compare this position data according to predefined rules with the location coordinates of the toll objects stored in the geographic database, in order, in the case of sufficient correspondence of the positioning data with the location coordinates, to identify the use of the respective toll object, in this case the route section of one roadway of a toll-liable freeway section, to register it as data element C, and to store a basic toll fee, coupled to the use of this route section, in the toll data memory 253 b.

The processor 253 is also configured to receive measured values of the vehicle speed from the GNSS position-determining device 257 and to compare these measured values in an unprocessed form or in a mathematically processed form (for example a weighted mean value of the first and of the second speed information) with a limiting value of the vehicle speed which is 30 km/h, and given undershooting of this limiting value by one of the measured values to detect automatically the occurrence of an exceptional traffic event for the second vehicle 25 and to generate in respect thereof a data record which comprises data elements A, B and C, of which A represents the traffic event justification of the undershooting of the limiting speed, B represents a time of the detection received by the clock 254 a, and C represents the registered route section, and to store this first data record in the program and operating data memory 253 a.

In addition the processor 253 is configured to transmit the traffic-event-dependent data record ABC to the central data processing unit 51 of a toll control center 50 by means of the mobile radio communication device 256, without divulging the identity of the vehicle 25 or of its vehicle device to the central data processing unit. For this purpose, the mobile radio communication device 256 of the vehicle 25 enters into a wireless communication connection to the mobile station 42 of a mobile radio network, the switching center 45 of which mobile station 42 anonymizes or pseudonymizes the identity of the mobile radio communication device 256 with respect to the central data processing unit 51 (FIG. 7).

The vehicle devices (not illustrated) of the first vehicles 11, 12, 13, 14 and 16 and the third vehicles 38 and 39 are at least functionally identical to the vehicle device 250 of the second vehicle 25; they are preferably structurally identical. Their processors are designed to receive, process and store data in the same or an analogous way and to transmit data records of the ABC type via the mobile radio communication devices thereof to the central data processing unit 51, like the processor 253 of the vehicle device 250 of the second vehicle 25. Every first vehicle 11, 12, 13, 14 and 16 transmits a first message only once, and the second vehicle 25 transmits a second message once, which messages each comprise a data record ABC, given connection to the end of the traffic jam via their participation in the formation of the traffic jam to the central data processing unit 51 (FIG. 5b, FIG. 7). The same message is not transmitted multiply owing, on the one hand, to the singularity of the receiver, inherent in the central nature of the toll system, and, on the other hand, owing to the fact that, for reasons of data protection, the identity of the transmitter is not disclosed, which prohibits central reduction of redundant messages which are limited to one source.

Furthermore, the processor 253 is designed to detect, on the basis of the speed information transmitted by the GNSS position-determining device, the exceeding of a recommended speed of 60 km/h and therefore to detect the breaking-out of the traffic jam configuration as an exceptional traffic event if said processor 253 has previously detected undershooting of the limiting speed of 30 km/h (see above), and to store an associated data record ABC, which represents the breaking-up of the traffic jam in the data element A, and to transmit it as a third message to the central data processing unit via the mobile radio communication device 256. This behavior applies to the third vehicles 38 and 39 which are involved in the breaking-up of the traffic jam in the further course of the road (FIG. 5b, FIG. 7).

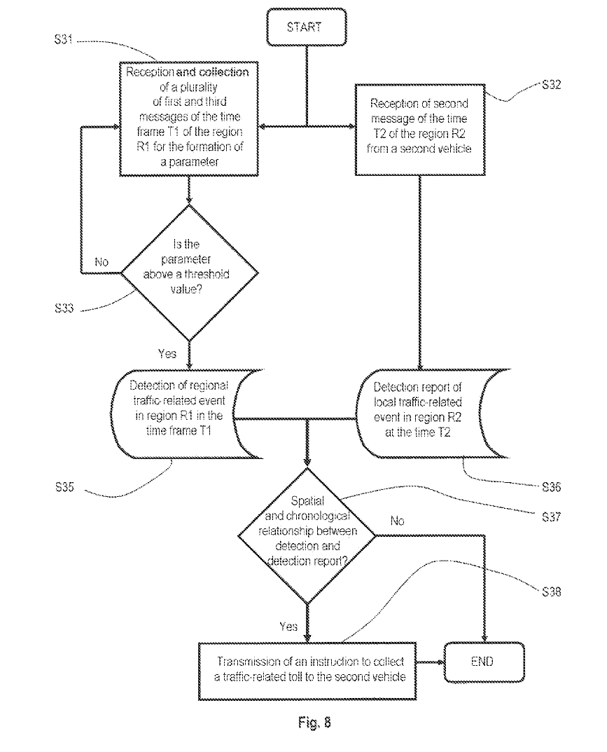

The central data processing unit is designed to receive all the first and third messages and the second message (steps S31 and S32 in FIG. 8) and to collect them by storage in a data memory, wherein it is to be noted once more that the first messages and the second message are of a different nature, specifically toll-collection debiting, than the third messages which have a toll-collection-crediting effect, as explained in more detail below.

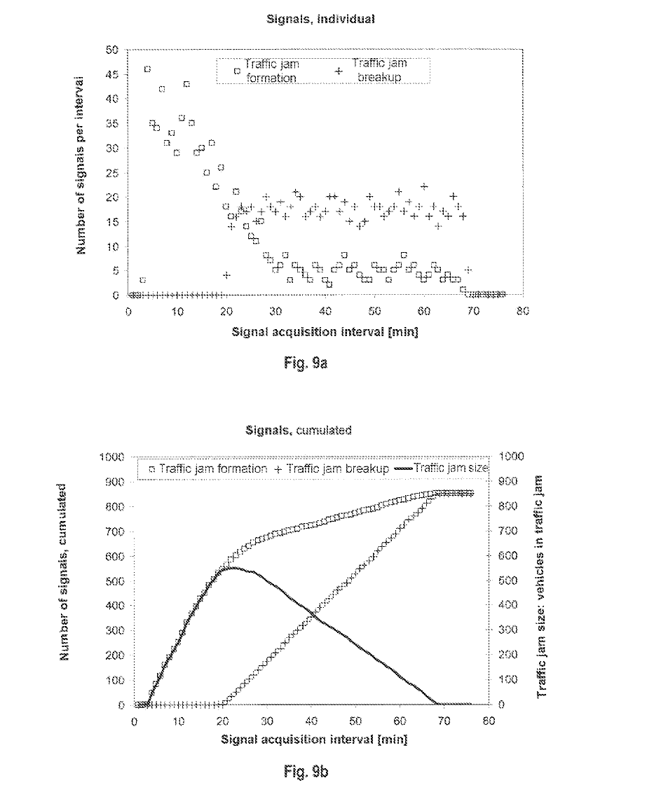

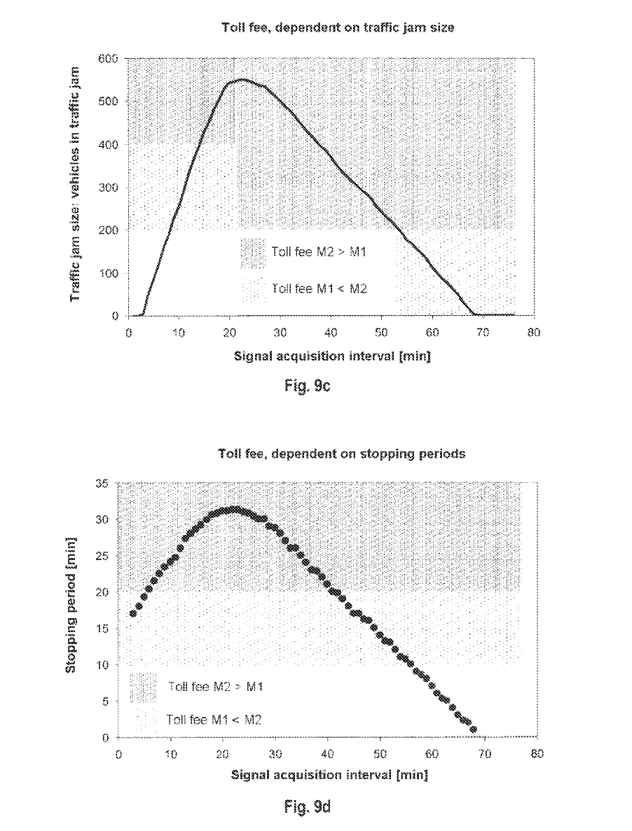

The collection of the messages begins with reception of a first message of the type A=traffic jam formation of the third vehicle 38 of the route section C=R1. Its time value B defines the start of the time frame T1 within which further first messages of the vehicles of the third vehicle 39 and finally first vehicles 11, 12, 13, 14 and 16 are received. The number of received signals of this type of one-minute time interval is illustrated graphically in FIG. 9 by the square traffic jam formation symbol.

Third messages of the third vehicles 38 and 39 of the type A=breaking-up of traffic jam, represented graphically in FIG. 9a for all the vehicles on a time interval basis with the cross symbol of the breaking-up of the traffic jam, also occur in this time frame. A cumulative representation of the traffic jam formation signals and of the traffic jam breakup signals is illustrated in FIG. 9b together with the size of the traffic jam as differences between the cumulated numbers of traffic jam formation signals and traffic jam breakup signals on the basis of the continuous line. The time frame T1 is progressed dynamically as long as the traffic jam size as a first formed parameter does not drop below a value of 1% of its maximum. The maximum traffic jam size is 551 vehicles, which gives rise to a maximum traffic jam length of about 2 kilometers on a two-lane roadway. The central data processing unit is designed to form, on the basis of the received first and third messages, said parameter of the traffic jam size and to compare it with a threshold value for a traffic jam size of a magnitude of 200 signals (that is to say vehicles), in order to detect traffic jam formation as a regional, traffic-related event on the route section R1 (S35).

The reception of the second message in step S32 from the route section C=/R2 with the time value B=T2, with which the central data processing unit detects a local traffic-related event on the route section R2, also occurs in the time frame T1.

By comparison with the region R1 and the time frame T1 of the first and third messages, the central data processing unit either detects that the second vehicle 25 is involved in the toll-liable traffic jam event of the first and third vehicles—for example in that the central data processing unit detects that the region R2 is identical to the region R1 and the time T2 occurs in the time frame T1. This is equivalent to the second vehicle being detected as a first vehicle in the left-hand section of the flowchart, and the right-hand section of the flowchart becomes obsolete.

In another case, the central data processing unit 51 detects that R2 represents a route section which precedes the route section R1 counter to the direction of travel. There is therefore a spatial relationship between the two route sections R1 and R2 because it may, of course, be the case that the traffic jam is expanding counter to the direction of travel from the first route section R1 to the second route section R2. In this case, the central data processing unit 51 is designed to acquire further first messages and to detect on the basis of the transmitted route sections that first messages decrease with route sections R1 and finally fail to occur and instead first messages increase with route sections R2 and finally occur alone.

If the spatial relationship of the transmitted route section R2 with the route sections R1 is absent, for example because the route section R2 is spaced apart from the first route section R1 by one or more further route sections R3, R4, there is no spatial relationship between the second message and the first and third messages, with the result that a collection of tolls for the second vehicle fails to occur at least with respect to a toll-determining group of vehicles which is based on first and third vehicles. Instead, it may be the case that the second vehicle belongs to another toll-determining group of vehicles, which could alternatively be checked by the central data processing unit 51 in another section (not illustrated) of the flowchart in FIG. 8.

The determination of the occurrence of the necessary spatial and chronological relationship between the detection of S35 and the detection of S36 by comparison of S37 gives rise, as a result thereof, to the transmission of an instruction to collect a traffic-related toll from the central data processing unit 51 to the second vehicle 25.

As an alternative to this, the determination of the absence of the necessary spatial and chronological relationship between the detection of S35 and the detection of S36 by comparison of S37 gives rise as a result to the transmission of a message from the central data processing unit 51 to the second vehicle 25 which states that an instruction to collect a traffic-related toll fails to occur.

In both cases, both the processor 253 of the vehicle device 250 and the central data processing unit 51 are designed to maintain the mobile radio communication link between the vehicle device 250 and the central data processing unit 51, which was set up by the vehicle device 250, and not to end said link until the corresponding message (instruction to collect a traffic-related toll or message about the failure of such an instruction to occur) has been transmitted from the central data processing unit 51 to the vehicle device 250 of the second vehicle 25.

While the traffic jam formation messages act on the traffic jam size in an increasing fashion, the traffic jam breakup messages act on the traffic jam size in a reducing fashion, and also in a reducing fashion on the duration of time for which the vehicles are in the traffic jam on average. This is significant for toll fees which are dependent on the traffic jam length from the time of the time value T2 of the second message or dependent on the duration of time for which a vehicle has been in the traffic jam.

In a first variant of the third exemplary embodiment, traffic-jam-size-dependent and traffic-jam-development-dependent toll fees are provided which vary depending on the traffic jam phase (formation, breakup) and traffic jam size (more than 200 vehicles involved, more than 400 vehicles involved). For this purpose, the central data processing unit evaluates traffic jam formation messages of first and second vehicles 11, 12, 13, 14, 16 and 25 together with the traffic jam breakup messages of third vehicles 38 and 39. According to FIG. 9c, a second vehicle which belongs to a group of less than 201 vehicles in the traffic jam in the traffic jam formation phase does not receive an instruction for the collection of a toll fee. A second vehicle, which in the traffic jam formation phase belongs to a toll-determining group of more than 200 vehicles but less than 401 vehicles, receives an instruction for the collection of a toll fee M1 of 2 euros. A second vehicle, which in the traffic jam formation phase belongs to a toll-determining group of more than 400 vehicles but less than 601 vehicles, receives an instruction for the collection of a toll fee M2 of 3 euros. A second vehicle, which in the traffic jam breakup phase belongs to a toll-determining group of more than 200 vehicles but less than 601 vehicles, receives an instruction for the collection of a toll fee M2 of 3 euros. A second vehicle which in the traffic jam breakup phase belongs to a toll-determining group of less than 201 vehicles, receives an instruction for the collection of a toll fee M1 of 2 euros.

Such differentiation of the toll fees avoids the imposition of penalties on those car drivers which are not to blame for the formation of the traffic jam because it was not possible for the information about the traffic jam to be available to them at a time at which they could still have left the road where the traffic jam occurred.

In a second variant of the third exemplary embodiment, individual traffic-jam-duration-dependent toll fees are provided which are dependent on the duration of time for which the second vehicle has been in the traffic jam. For this purpose, the central data processing unit evaluates traffic jam breakup messages of third and second vehicles 38, 39 and 25 which comprise a first time of the involvement of the respective vehicle in the formation of the traffic jam (first detection of the undershooting of the limiting speed) and a second time of the involvement of the respective vehicle in the breakup of the traffic jam (second detection of the exceeding of a recommended speed), wherein the third vehicles 38 and 39 are considered in this case to be first vehicles which form, together with the second vehicle, the toll-determining vehicle group which is valid for the second vehicle. According to FIG. 9d, a second vehicle whose time spent in the traffic jam is shorter than 10 minutes does not receive an instruction for the collection of a toll fee. A second vehicle whose time spent in the traffic jam is not shorter than 10 minutes but is shorter than 20 minutes receives an instruction for the collection of a toll fee M1 of 1.50 euros. A second vehicle whose time spent in the traffic jam is not shorter than 20 minutes but is shorter than 30 minutes, receives an instruction for the collection of a toll fee M2 of 2.50 euros.

Such differentiation of the toll fees avoids imposition of a penalty on those car drivers which are not to blame for the high traffic density which has promoted formation of a traffic jam but rather only traveled on the road after communication of a reduced traffic density, even if a traffic jam (which was breaking up) was still being indicated on said road.

In alternative or optional variants of the third exemplary embodiment it is possible to provide for the traffic density to be used as a toll-metering basis, as a result of which the toll fee becomes dependent on the number of traffic jam formation messages which are acquired per time interval of a minute according to FIG. 9a by the central data processing unit 51. The driver of a toll-liable vehicle can in fact obtain information about a high traffic density posing a risk of a traffic jam, even before said driver travels on a road or before he makes his decision not to leave the road.

Furthermore, a stopping behavior of vehicles at rest stops and gas stations, which is independent of a traffic jam, can therefore be differentiated in a toll-free fashion from a toll-liable traffic jam which has a higher vehicle message frequency.

Independently of this, a driving behavior of vehicles at rest stops and gas stations which is independent of a traffic jam can already be detected in the vehicle devices 250 in that such a typical stopping location is identified by the processor 253 by comparing the position data of the vehicle at the detection time with location data of the stopping location stored in the geographic database 253 c, with the result that the detection is cancelled and/or the transmission of an event-related message is prohibited.

As well as being designed to receive an instruction to collect a toll fee by means of the mobile radio communication device 256 via the mobile radio network, the processor 253 of the vehicle device 250 of the second vehicle 25 is also designed to implement the instruction for the collection of the toll fee in that it stores the traffic-related additional toll fee in the toll data memory 253 b, as a result of which the traffic-related toll is collected. In addition, the processor is designed to transmit toll fees which have occurred regularly and/or in an event-related fashion and are stored in the toll data memory 253 b, to a central data processing unit of a toll operator or of a toll collection service provider via a mobile radio network by means of the mobile radio communication device 256 of the vehicle device 250.

In an alternative embodiment of the third exemplary embodiment, it is possible to dispense with the transmission of an instruction for the collection of a traffic-related toll from the central data processing unit 51 to the second vehicle 25 if instead the vehicle device 250 communicates the identity of the second vehicle, and the central data processing unit 51 is designed to implement itself the generated instruction for the collection of the traffic-related toll relating to the second vehicle 25 in that said data processing unit 51 adds the corresponding toll fee to a fee account of the second vehicle in a fee database and therefore, likewise according to the invention, collects the traffic-related toll for the second vehicle 25.

Instead of a traffic jam, it is also possible in an analogous fashion to charge tolls for slowly moving traffic. Instead of involving a plurality of first vehicles in a toll-determining group, a single first vehicle can also be sufficient, wherein the toll-determining group is composed of not more than a first and a second vehicle.

### Fourth Exemplary Embodiment

### Common Features of the Vehicle Devices of the Preceding Exemplary Embodiments

The vehicle devices 250 of the first, second and third exemplary embodiments have in common their property of detecting a route section in the course of traveling thereon and of adjusting the function of the vehicle device in dependence on the property of the route section with respect to a liability to pay a possible traffic-related toll fee (traffic-related toll liability) or of an exemption from the payment of a traffic-related toll fee (exemption from a traffic-related toll). Insofar as travel on a route section which is subject to a traffic-related toll liability means traveling on a toll-free route section, the vehicle device 250 is designed to interpret the detected non-use (for example the exiting) of a route section which is subject to a traffic-related toll liability as travel on a toll-free route section.

For this purpose, the processor 253 receives position data of the GNSS position-determining device 257 and compares the received position data with the geographic coordinates of Geo entry objects from the geographic database 253 c which represent the travel on a route section which is subject to a traffic-related toll liability. In the case of the position data corresponding to the geographic coordinates of such a Geo entry object of a specific route section which is subject to a traffic-related toll liability, the processor 253 adjusts the vehicle device 250 from a rest mode, specified in the next paragraph, to a reporting mode in which the processor 253 can compare the measured values received from the sensor device 252, 257 and/or 258 with threshold values, can produce detection reports, generate data of this detection report and transmit said data within the scope of a message by means of the car-2-car communication device 251 in the case of the first and second exemplary embodiment or by means of the mobile radio communication device in the case of the third exemplary embodiment, and in the case of the first and second exemplary embodiments can receive messages from functionally identically operating vehicle devices by means of the car-2-car communication device 251.

If the comparison of the received position data with the geographic coordinates of Geo exit objects from the geographic database 253 c, which represents the exiting of a route section which is subject to a traffic-related toll liability, reveals correspondence of the position data with the geographic coordinates of such a Geo exit object of a specific route section which is subject to a traffic-related toll liability, the processor 253 adjusts the vehicle device 250 from the reporting mode described in the preceding paragraph into a rest mode in which the processor receives measured values from the sensor devices 252, 257 and/or 258 for fault determination purposes, but does not compare said measured values with threshold values and in this respect cannot produce detection reports and also cannot transmit and/or receive any data of detection reports in the inventive sense, wherein, in particular, the car-2-car communication device 251 is deactivated with respect to use in the inventive sense.

Neither the reference signs of the exemplary embodiments nor the exemplary embodiments themselves restrict in any way the scope of protection of the patent claims whose reference signs serve only to illustrate the invention with reference to the appended drawings.

1. A method for collecting a traffic-related toll fee for at least one vehicle which is part of a toll-determining group of a plurality of vehicles, comprising:
radio reception of at least a first message which was generated by a first vehicle as a result of at least one first detection report made by at least one first vehicle about the occurrence of an exceptional traffic event, and was transmitted by radio, including data of the first detection report,
the production of a second detection report about the occurrence of an exceptional traffic event by a second vehicle, and
the collection of a traffic-related toll fee for the first vehicle and/or the second vehicle,
if a comparison of data of the first detection report from the first message and data of the second detection report in the course of data processing of this data by a processor reveals a similarity between these data items within a predefined scope, which similarity causes that the first vehicle and the second vehicle are assigned to the toll-determining group.

2. The method as claimed in claim 1, wherein the data processing by comparing chronological data of the first detection report and of the second detection report concludes with the result that the chronological data lies within a predefined time frame.

3. The method as claimed in claim 1, wherein
the data processing by comparing local data and/or direction-of-travel-related data of the first detection report and of the second detection report concludes with the result that the local data lies within a predefined spatial region and/or the direction-of-travel-related data lies within a predefined angular range.

4. The method as claimed in claim 1, wherein
the first vehicle and the second vehicle each have a vehicle device with a sensor device, wherein the sensor device acquires in each case at least one measured value of a measurement variable which is representative of an exceptional traffic event, and the vehicle device compares the acquired measured value with a limiting value for this measurement variable, in order to detect the exceptional traffic event of the exceeding or undershooting of this limiting value by the measured value, and to generate data of this detection.

5. The method as claimed in claim 1, wherein the data processing of the first message and of the second detection report is carried out by a processor which is included in a vehicle device of the second vehicle and is coupled in terms of data technology to a radio receiver device of the second vehicle in order to receive the first message.

6. The method as claimed in claim 5, wherein the collection of a traffic-related toll fee for the second vehicle, which is brought about by the result of the data processing of data of the first detection report and of the second detection report, by
subtracting a toll fee amount from an electronic toll credit of a toll credit data memory which is included in the vehicle device of the second vehicle, or by
adding a toll fee amount to an electronic total toll liability of a total toll liability data memory which is included in the vehicle device of the second vehicle.

7. The method as claimed in claim 5, characterized by transmission, brought about by the result of the data processing of data of the first detection report and of the second detection report, of an instruction for the collection of a traffic-related toll fee from the vehicle device of the second vehicle via a mobile radio link between the vehicle device of the second vehicle and a central data processing unit of the toll system to the central data processing unit for the collection of the transferred, traffic-related toll fee, relating to the first vehicle and/or the second vehicle, by the central data processing unit.

8. The method as claimed in claim 1, wherein
the data processing is carried out by a processor which is included in a central data processing unit of the toll system or formed thereby and is coupled in terms of data technology to at least a first radio receiver device for receiving the first message and a second message which was generated by the second vehicle owing at least to the second detection report made by the second vehicle, including data of the second detection report, and was transmitted by radio.

9. The method as claimed in claim 8, wherein
the first message and the second message are each transmitted to the central data processing unit via a mobile radio link, and wherein
an instruction, brought about by the result of the data processing of the first messages, for the collection of a traffic-related toll fee is transmitted by the central data processing unit, via a mobile radio link between the central data processing unit and the second vehicle, to the second vehicle, and wherein the instructed, traffic-related toll fee is collected by a vehicle device of the second vehicle.

10. The method as claimed in claim 9, wherein
during the time period between the transmission of the second message from the second vehicle to the central data processing unit and the transmission of the toll collection instruction or a message to the effect that the transmission of a toll collection instruction from the central data processing unit to the second vehicle does not occur, the mobile radio link between the second vehicle and the central data processing unit is maintained uninterruptedly.

11. The method as claimed in claim 1, wherein
the data processing comprises
the collection of a plurality of first messages with chronological data of first detection reports of a plurality of first vehicles,
the counting of first messages, the chronological data of which lies within a predefined time frame,
the determination of a parameter which depends on the number of counted first messages, and
the detection of a toll-incurring traffic situation on the basis of the comparison of the parameter with a predefined threshold value if the comparison reveals that the parameter exceeds or undershoots the predefined threshold value,
wherein
the collection of the traffic-related toll fee takes place only when the toll-incurring traffic situation is detected.

12. A vehicle device for collecting a traffic-related toll fee for at least one vehicle which is part of a toll-determining group of a plurality of vehicles, wherein
the vehicle device has a radio receiver device,
wherein
the vehicle device is included in a second vehicle and is configured for
producing automatically a detection report about the occurrence of an exceptional traffic event,
receiving at least a first message from at least a first vehicle via the radio receiver device,
comparing with one another data items of the first message and of the detection report in the course of data processing of these data items, and
for, when determining a similarity between the data items within a predefined scope, detecting an assignment of the first vehicle and of the second vehicle to the toll-determining group, and
as a result
i) collecting a traffic-related toll fee relating to the second vehicle and/or
ii) transmitting an instruction for the collection of a traffic-related toll fee relating to the first vehicle and/or to the second vehicle to a central data processing unit via a radio transmitter device.

13. The vehicle device as claimed in claim 12, wherein
the vehicle device comprises a sensor device which acquires at least one measurement variable which is representative of at least one predefined traffic situation, and wherein
the vehicle device is configured for determining the acquired measurement variable with a limiting value for this measurement variable, in order to produce the detection report about the occurrence of an exceptional traffic event on the basis of this limiting value being exceeded or undershot, and for generating data of this detection report.

14. A central data processing unit for collecting a traffic-related toll fee for at least one vehicle which is part of a toll-determining group of a plurality of vehicles,
wherein
the central data processing unit configured
for receiving at least one first message, which is triggered in relation to traffic and transmitted by radio, from at least one first vehicle,
receiving at least one second message, which is triggered in relation to traffic and transmitted by radio, from at least one second vehicle, and
processing the first message and the second message,
in order to generate an instruction for the collection of a traffic-related toll fee for the second vehicle if
a comparison, which has taken place in the course of the data processing, of data of the first message and of the second message reveals a similarity of data of the first message with data of the second message within a predefined scope, as a result of which
the first vehicle and the second vehicle are assigned to the toll-determining group of vehicles.

15. A toll system comprising a plurality of vehicle devices, which are distributed among various vehicles as claimed in claim 12 and/or at least one central data processing unit as claimed in claim 14 and/or configured for carrying out a method as claimed in claim 1.
